(19) United States
(12) Patent Application Publication
(10) Pub. No.: US 2010/0133488 A1
(43) Pub. Date: Jun. 3, 2010

(54) MOLECULAR AND PHOTONIC NANOSTRUCTURES, OPTICAL BIOMATERIALS, PHOTO-SENSITIZERS, MOLECULAR CONTRAST AGENTS AND METAMATERIALS

(75) Inventor: George Giakos, Fairlawn, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/445,531

(22) PCT Filed: Oct. 31, 2007
(86) PCT No.: PCT/US07/23018

§ 371 Date: Jan. 6, 2010

Related U.S. Application Data
(60) Provisional application No. 60/937,795, filed on Jun. 29, 2007.
(60) Provisional application No. 60/855,944, filed on Oct. 31, 2006.

(51) Int. Cl. F21V 9/00

(52) U.S. Cl. 252/582

(57) ABSTRACT

The present invention generally relates to new photophysical characteristics associated with certain macromolecules, heterogeneous phases with a pronounced index of refraction contrast, and biological complex macromolecules. Given this, in one embodiment the present invention relates to new processes, methods and applications, for enhancing signals and images. In another embodiment, the present invention relates to the design and development of scalable imaging systems and techniques, optical instrumentation and lenses, systems engineering, photonics and optoelectronics, low-power microelectronics, micro-nanotechnology, and sensing/biosensing applications for various applications (e.g., life science applications).

### FIELD OF THE INVENTION

The present invention generally relates to new photophysical characteristics associated with certain macromolecules, heterogeneous phases with a pronounced index of refraction contrast, and biological complex macromolecules. Given this, in one embodiment the present invention relates to new processes, methods and applications, for enhancing signals and images. In another embodiment, the present invention relates to the design and development of scalable imaging systems and techniques, optical instrumentation and lenses, systems engineering, photonics and optoelectronics, low-power microelectronics, micro-nanotechnology, and sensing/biosensing applications for various applications (e.g., life science applications).

### BACKGROUND OF THE INVENTION

The interaction of macromolecules and biological material with light integrates major technologies such as photonics, nanotechnology, and biotechnology, and is leading to new research frontiers such as molecular photonics and molecular nanophotonics. These emerging frontiers are promising to a large variety of disciplines such as medicine, biology, bioengineering, advanced diagnostic, analytical devices and instrumentation, including nano-instrumentation, defense, and homeland security. Photonic crystals are appealing for controlling light wave propagation by introducing pre-engineered defects into an otherwise regular lattice structures to create spectral filters, tight bend waveguides, resonant cavities, and highly efficient lasers.

In general, many photonic structures are composed of two or more dielectrics. The absolute value of the refractive index contrast is critical to the performance of such materials. Accordingly, increasing the index contrast between such materials would therefore be very desirable.

Photonic crystals can be viewed as a subclass of a larger family of material systems called metamaterials in which the properties of such materials properties are largely derived from their structure rather than from the composition of the material itself. Metamaterials, an extension of the concept of artificial dielectrics, typically consist of periodic structures of a guest material embedded in a host material. One distinct feature of metamaterials is that they facilitate the delivery of optical gain media, nonlinear liquids, and/or colloidal nanoparticles (e.g., gold nanoparticles). The optimization of component materials and geometries can yield metamaterials with unique optical properties which can allow such metamaterials to control light in unconventional ways with potential applications in photonic integration.

Electric polarization may be defined as the electric field induced disturbance of the charge distribution in a region. This polarization does not occur instantaneously, and the associated time constant is called the relaxation time τ. The relaxation of electrons and small dipolar molecules is a relatively fast process, with relaxation times in the pico- and nanosecond range, while interfacial polarization could give relaxation times of the order of seconds.

Overall, metamaterials can be divided into two categories: (a) ultra-low-refractive-index metamaterials; and (b) high-index of refraction metamaterials. Research efforts on ultra-low-refractive-index metamaterials are focused on achieving an effective refractive index of less than unity at optical frequencies. Ultra-low-refractive-index metamaterials possess unique optical phenomena, at visible wavelengths, such as the phenomenon of total internal reflection. Total internal reflection is well known in optical waveguides, where the index of the core material is greater than that of the cladding. Based on numerical simulations, slab waveguides with hollow cores (high index of refraction) and metamaterial cladding (low index of refraction) are feasible for visible and NIR wavelengths. On the other hand, the design of metamaterials with arbitrary high, positive indices of refraction could potentially lead to the development of miniaturized optical or electromagnetic devices, with enhanced imaging resolution.

The development of macroscopic and nano-instrumentation imaging systems and techniques that would be capable of providing molecular, biochemical, physiological, and metabolic information for medical and biological applications is of paramount significance. Although contrast agent-based techniques have been widely used for x-ray imaging applications, such as angiography, gastrointestinal (GI) endoscopy, nuclear medicine, and paramagnetic particles, to date no contrast enhancement techniques have been developed that enable bulk optical detection and imaging beyond the use of optical nanostructures and fluorophores for dedicated nano-microscopy applications.

Optical imaging and target detection and identification, through scattering media, although an emerging technology, have been explored by a number of authors. Optical polarimetry relies on polarimetric information obtained through backscattered light from the target, while offering distinct signatures related to the target geometry, structure, and composition. Specifically, the polarization of the scattered light depends upon a number of geometrical, physical, chemical, physiological, and metabolic parameters, such as incident polarization state, surface smoothness, shape, size, color, orientation, and concentration of the scatter, as well as from the optical properties of the scatter, such as refractive indexes of the scatter, molecular structure, biochemical, physiological and metabolical functions of the target and the surrounding medium. Imaging formation through detection of the polarization states of light offers distinct advantages for a wide range of detection and classification problems, and have been explored for biomedical applications by a number of authors, due to the intrinsic potential of the optical polarimetry to offer high-contrast, high-specificity images under low-light conditions.

Given the above, optical imaging can provide a detailed description of biological tissues. For instance, it could permit the characterization of a variety of diseases, such as breast cancer, skin cancer, lung cancer, cancer of the bladder, and the analysis of molecular pathways leading to diseases. In addition, optical polarimetry could provide enhanced imaging and spectral polarimetric information regarding the metabolic information of a tissue, as well as the molecular mechanism of a biological function, drug-cell interaction, single-molecule imaging, and so on. Image formation through detection of the polarization states of light offers distinct advantages for a wide range of detection and classification problems, and have been explored by a number of authors, due to the intrinsic potential of the optical polarimetry to offer high-contrast, high-specificity images under low-light conditions.

Additionally, optical polarimetry relies on polarimetric information obtained through backscattered light from the target, while offering distinct signatures related to the target geometry, structure, and composition. Specifically, the polarization of the scattered light depends upon a number of geometrical, physical, chemical, physiological, and metabolic parameters, such as incident polarization state, surface smoothness, shape, size, color, orientation, and concentration of the scatter, as well as from the optical properties of the scatter, such as refractive indexes of the scatter, molecular structure, biochemical, physiological and metabolical functions of the target and the surrounding medium. Imaging formation through detection of the polarization states of light offers distinct advantages for a wide range of detection and classification problems, and have been explored for biomedical applications by a number of authors, due to the intrinsic potential of the optical polarimetry to offer high-contrast, high-specificity images under low-light conditions.

By referring to the early cancer detection and treatment, it is well established that one factor contributing to inaccurate staging and treatment assessment of cancer is the use of low-contrast or unreliable imaging procedures. Conventional x-ray imaging systems produce images based on the structure of the tissue; and thus, the resulting signal provides only anatomical information, without any physiological or metabolic signature. Indeed, ultrasound imaging, magnetic resonance imaging (MRI), and computed tomography imaging (CT) rely basically on the ability to differentiate the tumor against the surrounding tissue and inherent background noise. As a result, they can produce signals with little sensitivity or specificity. Therefore, more sensitive and specific imaging, utilizing the above mentioned dopants, can play an important role in the diagnosis and treatment of cancer. Better, imaging allows diagnosis and therapy to be addressed selectively to the tumor, and can be used to better facilitate localized surgical interventions, such as ablation, endoscopy, and lumpectomy, that allow limited diseased areas to be treated more drastically. Better imaging can also facilitate minimally invasive monitoring of therapeutic response. As a result, the use of dopants in conjunction with polarimetric detection/imaging techniques provides excellent results and an area for additional gains and contributes effectively towards the detection and imaging of specific molecular signatures in vivo providing physiological and metabolic information at the molecular level.

The key features of the novel principles of this invention consist on the interrogation of targets or samples with multiple wavelengths forming multi-spectral Stokes Parameters and Mueller Matrix polarimetric difference images, obtained at different wavelengths. For instance, the use of two Mueller-matrix polarimetric optical images, one produced from a high energy (small wavelength) and another from a low energy (large wavelength) laser beams, and the subsequent subtraction of these two images, can produce high-contrast polarimetric energy image difference which eliminates or minimizes interfering background and clutters, or enhances the image process. Further image enhancement can be achieved by subtracting Stokes polarimetric parameter images and the like, obtained at different optical wavelengths, such as degree of linear polarization images (DOLP)'s.

These images can be further manipulated, or combined, to enhance the detection process. As a result, the presented principles can provide spectral, energy, and polarimetric information altogether. Specifically, the acquired polarimetric information, obtained at multiple wavelength interrogation of the target, at differed depths of interaction (scattered planes), includes basically polarization-based amplitude contrast information (di-attenuation property of the target) polarization-based phase contrast information (birefringence property of the target), and depolarization contrast. Furthermore, Mueller matrix decomposition at different wavelengths, and subsequent subtraction of the imaging parameters, can enhance the detection process, significantly. In addition, the presented optical principles allows one to obtain enhanced image formation through detection of polarimetric signatures, giving rise to degree of polarization (DOP) images, degree of linear polarization (DOLP) images, degree of circular polarization (DOCP) images, ellipticity images, azimuth images, and eccentricity images, and their multispectral image differences such as DOP difference, DOLP, difference, DOCP difference. This can increase by n-fold the signal-to noise ratio of the detected targets. The same principles can be also combined with an active or passive multispectral spectropolarimeter or multispectral/hyperspectral imaging system for enhanced imaging. As a result, a multi-wavelength, multi-fusion optical imaging system with enhanced contrast and specificity can be obtained. In addition, these novel optical principles can contribute towards the development of mono-static polarimetric laser reflectometers, bistatic polarimeter laser reflectometers, or as a network of several polarimeters operating in reflection or transmission or any combination of these modes. They can be also implemented with super-resolution techniques, by means of hardware or software based solutions, as well enhance the image content at various depths (scattering planes) of the object, by providing polarized multi-wavelength planar image sections. As a result, enhanced Mueller matrix/Stokes parameters-based image differences confocal microscopy systems, with enhanced scatter rejection, can result.

Interestingly enough, the proposed imaging detection principles, depending upon specific applications and scenarios, can provide real, multi-scale fusion of the converging data, as well as real time analysis and processing, using electrooptical non-moving-phase retarder systems, fast processing, and robust computational platforms, by means of wavelets for feature extraction, and compression, as well as advanced neural fuzzy or classical processing techniques, for optimization and suitable choice of the laser light wavelengths at different physical conditions and scenarios as well as for image enhancement and processing.

The advantages of the presented imaging principles are: the ability to provide enhanced multispectral spectral polarimetric subtraction images, based on Mueller matrix principles, and Stokes polarization parameters; improved image quality over a wide range of imaging sensing platforms because; the light excitation of the target and the reflected light spectra are both independent of variable and unpredictable sun or external light illumination. As a result, active systems require detection of much narrower spectral bands than passive systems because the signatures have less variability due to time-varying signature properties such as sun illumination or target temperature; the ability to characterize the state of polarization of radiation from each pixel of a target scene by measuring all four components of the Stokes vector, from the 16 Mueller Matrix elements, as a function of wavelength to yield high contrast resolution, high spatial resolution, and specificity images; unlike current technology, the presented physical principles could provide enhanced images in cluttered target media, adverse weather/environmental conditions, low-light conditions; the acquired images provide multifunctional information and distinct signatures related to the target material composition as well as to the morphology, physiology, chemical, biochemical, and metabolic functions of the target; the spectral distribution of the illuminating lasers can be tuned to interrogate a specific target.

The experimental results of this invention indicate clearly that, high-contrast Stokes parameter polarimetric backscattered light spectral image differences, such as Degree of Linear Polarization (DOLP) images, can be obtained from targets embedded in scattered media. Further feature extraction enhancement can be obtained by processing the polarimetric images with wavelet transform algorithms. In addition, by introducing a high index of refraction polar molecules/nanoparticles into solvents, enhanced detection and light beam steering characteristics result, with possible implications to enhanced imaging and effective treatment of tumors as well as to the development of novel optical and nanophotonic devices.

### SUMMARY OF THE INVENTION

The present invention generally relates to new photophysical characteristics associated with certain macromolecules, heterogeneous phases with a pronounced index of refraction contrast, and biological complex macromolecules. Given this, in one embodiment the present invention relates to new processes, methods and applications, for enhancing signals and images. In another embodiment, the present invention relates to the design and development of scalable imaging systems and techniques, optical instrumentation and lenses, systems engineering, photonics and optoelectronics, low-power microelectronics, micro-nanotechnology, and sensing/biosensing applications for various applications (e.g., life science applications).

In one embodiment, the present invention relates to a multi-energy imaging system comprising: (a) at least one energy source for irradiating a target with at least one quantity of light and at least one quantity of energy, the at least one quantity of light comprising at least one wavelength of light and the at least one quantity of energy comprising at least one wavelength of energy, wherein the wavelength of the energy is either shorter or longer than the wavelength of the at least one quantity of light; (b) a polarization-state generator for generating a polarization state for each quantity of light, the polarization-state generator comprising at least one polarizer, each polarizer being adapted to polarize an individual wavelength before the one or more quantities of light enter a first waveplate; (c) a polarization-state receiver for evaluating a resulting polarization state of each of the one or more quantities of light following illumination of the target, the polarization-state receiver comprising a second waveplate through which the one or more quantities of light are transmitted before entering at least one second polarizer; (d) an image-capture device for capturing at least a first image and a second image of the target irradiated by the at least one quantity of light and the at least one quantity of energy, the first image corresponding to an image of the target generated from the wavelength of light and the second image corresponding to an image of the target generated from the wavelength of energy; and (e) a processing unit for assigning a weighting factor to at least one of the first and second images and evaluating a weighted difference between the first and second images to generate a multi-wavelength image of the target, wherein the system utilizes at least one dopant to enhance at least one detection characteristic of the target.

In one embodiment, the dopant for use in conjunction with above multi-energy imaging system is selected from, or contains, one or more polar molecules, one or more nanocomposites, one or more nanoparticles, one or more nanopolymers, one or more salts, one or more dipolar ions, one or more zwitterions, one or more ionic surfactants, one or more enzymes, one or more proteins, one or more amino acids, one or more high refractive index dielectric molecules, one or more macromolecules, one or more nanostructures, one or more fluorescent particles, one or more high index of refraction molecules, one or more polar and non-polar organic and inorganic macromolecules, one or more optically active molecules, one or more chiral molecules, one or more polymers, one or more copolymers, one or more nano-polymers, one or more biological block copolymers, one or more proteins, one or more enzymes, one or more peptides, one or more surfactants, one or more liquid crystal particles, or any suitable combination of two or more thereof.

In one embodiment, the above multi-energy imaging system utilizes a first waveplate that is a one-quarter (¼) waveplate. In one embodiment, the above multi-energy imaging system utilizes a second waveplate that is a one-quarter (¼) waveplate. In another embodiment, both the first and second waveplates are one-quarter (¼) waveplates.

In another embodiment, the present invention relates to a multi-energy imaging system comprising: (i) at least one light source for illuminating a target with at least one quantity of light, the at least one quantity of light comprising at least two wavelengths of light, a first wavelength and a second wavelength, the second wavelength being different than the first wavelength; (ii) a polarization-state generator for generating a polarization state for each quantity of light, the polarization-state generator comprising at least two polarizers, each polarizer being adapted to polarize an individual wavelength before the one or more quantities of light enter at least one first waveplate; (iii) a polarization-state receiver for evaluating a resulting polarization state of each of the one or more quantities of light following illumination of the target, the polarization-state receiver comprising at least one second waveplate through which the one or more quantities of light are transmitted before entering at least one second polarizer; (iv) an image-capture device for capturing at least a first image and a second image of the target illuminated by the at least one quantity of light, the first image corresponding to an image of the target generated from the first wavelength component of the at least one quantity of light and the second image corresponding to an image of the target generated from the second wavelength component of the at least one quantity of light; and (v) a processing unit for assigning a weighting factor to at least one of the first and second images and evaluating a weighted difference between the first and second images to generate a multi-wavelength image of the target, wherein the system utilizes at least one dopant to enhance at least one detection characteristic of the target.

In one embodiment, the dopant for use in conjunction with above a multi-energy imaging system is selected from, or contains, one or more polar molecules, one or more nanocomposites, one or more nanoparticles, one or more nanopolymers, one or more salts, one or more dipolar ions, one or more zwitterions, one or more ionic surfactants, one or more enzymes, one or more proteins, one or more amino acids, one or more high refractive index dielectric molecules, one or more macromolecules, one or more nanostructures, one or more fluorescent particles, one or more high index of refraction molecules, one or more polar and non-polar organic and inorganic macromolecules, one or more optically active molecules, one or more chiral molecules, one or more polymers, one or more copolymers, one or more nano-polymers, one or more biological block copolymers, one or more proteins, one or more enzymes, one or more peptides, one or more surfactants, one or more liquid crystal particles, or any suitable combination of two or more thereof.

In one embodiment, the at least one light source of the above multi-energy imaging system is used in combination with the at least one energy source, the at least one energy source being adapted to generate one or more wavelengths of energy in the gamma ray, X-ray, ultraviolet ray, infrared ray, radar, RF, microwaves and/or radio wave portions of the electromagnetic spectrum.

In another embodiment, there is one light source in the above multi-energy imaging system and the one light source is capable of simultaneously generating a quantity of light having at least two discrete wavelengths of light. In another embodiment, there is one light source in the above multi-energy imaging system and the one light source is capable of sequentially generating a quantity of light having at least two discrete wavelengths of light. In still another embodiment, there is two light sources in the above imaging system and each light source is capable of generating a quantity of light having one discrete wavelength of light.

In one embodiment, the above system utilizes an image-capture device that is a light image-capture device. In one instance, the image-capture device is an electro-optical device. In one instance, the electro-optical device is positioned in optical alignment with the polarization-state receiver to capture the first and second images. In one instance, the above system utilizes at least one light source that comprises at least one laser.

In another embodiment, the at least one light source of the above system is configured to emit energy in a planar geometry, fan-beam geometry, pointwise irradiation, or any combination thereof. In another embodiment, the first and second waveplates utilized in the above system are each a quarter-wave retarder. In another embodiment, the quarter-wave retarders forming the first and second waveplates are rotated at an angular-velocity ratio of 5:1.

In another embodiment, the polarization-state generator and the polarization-state receiver of the above system are generally linearly aligned on opposite sides of the target. In another embodiment, the polarization-state receiver of the above system is positioned to evaluate the resulting polarization state of each quantity of light reflected by the target.

In still another embodiment, the above system further comprises a computer readable memory for storing information to be used by the processing unit for determining a suitable wavelength for each quantity of light. In one embodiment, the processing unit of such a computer comprises an artificial fuzzy neural network that uses information stored in the computer readable memory to determine a suitable wavelength for each quantities of light for the conditions at a time when the multi-energy image is to be generated.

In still another embodiment, the image-capture device of the above system converts the first captured image into a first Mueller matrix of the target and the second captured image into a second Mueller matrix of the target in order to permit processing, comparison and/or combination of the Mueller matrices from first and second images. In still another embodiment, the image-capture device of the above system converts the first captured image into a first Stokes parameter image of the target and the second captured image into a second Stokes parameter image of the target in order to permit processing, comparison and/or combination of the Mueller matrices from first and second images.

In another embodiment, the present invention relates to a multi-energy imaging system comprising: (A) at least one light source for illuminating a target with at least one quantity of light, the at least one quantity of light comprising at least two wavelengths of light, a first wavelength and a second wavelength, the second wavelength being different than the first wavelength; (B) a polarization-state generator for generating a polarization state for each quantity of light, the polarization-state generator comprising at least one polarizer, each polarizer being adapted to polarize an individual wavelength before the one or more quantities of light enter through at least one rotating ¼ waveplate linear retarder; (C) a polarization-state receiver for evaluating a resulting polarization state of each of the one or more quantities of light following illumination of the target, the polarization-state receiver comprising at least one second rotating ¼ waveplate linear retarder through which the one or more wavelengths of light are transmitted before entering at least one second polarizer; (D) an image-capture device for capturing at least a first image and a second image of the target illuminated by the at least one quantity of light, the first image corresponding to an image of the target generated from the first wavelength of light and the second image corresponding to an image of the target generated from the second wavelength of light, wherein the image-capture device receives and/or generates for each of the at least first and second images at least 16 individual polarization-state measurements; and (E) a processing unit for comparing the at least 16 individual polarization state measurements from the at least first and second images, wherein the system utilizes at least one dopant to enhance at least one detection characteristic of the target.

In one embodiment, the dopant for use in conjunction with above a multi-energy imaging system is selected from, or contains, one or more polar molecules, one or more nanocomposites, one or more nanoparticles, one or more nanopolymers, one or more salts, one or more dipolar ions, one or more zwitterions, one or more ionic surfactants, one or more enzymes, one or more proteins, one or more amino acids, one or more high refractive index dielectric molecules, one or more macromolecules, one or more nanostructures, one or more fluorescent particles, one or more high index of refraction molecules, one or more polar and non-polar organic and inorganic macromolecules, one or more optically active molecules, one or more chiral molecules, one or more polymers, one or more copolymers, one or more nano-polymers, one or more biological block copolymers, one or more proteins, one or more enzymes, one or more peptides, one or more surfactants, one or more liquid crystal particles, or any suitable combination of two or more thereof.

In one embodiment, the 16 individual polarization state measurements from each image are averaged together by the processing unit to form average polarimetric images corresponding individually to at least the first and second images. In another embodiment, the first average polarimetric image of the target and the second polarimetric image of the target are subtracted from one another to obtain a weight spectral image difference of the target, wherein the first average polarimetric image corresponds to an average polarimetric image of the target generated using the data obtained at the first wavelength and the second average polarimetric image corresponds to an average polarimetric image of the target generated using the data obtained at the second wavelength.

In still another embodiment, the 16 individual polarization state measurements from each image are used to generate a Mueller matrix for one individual wavelength of light.

In another embodiment, the present invention relates to method for, generating an image of a target, the method comprising the steps of: (i) preparing and administering at least one dopant; (ii) emitting at least two quantities of energy, at least one quantity of energy being a quantity of light having a first wavelength, the second quantity of energy having a second wavelength different from the first wavelength, the second wavelength being selected from the gamma ray, X-ray, ultraviolet ray, visible, infrared ray, radar, RF, microwaves, and/or radio wave portions of the electromagnetic spectrum; (iii) creating an initial polarization state for at least the one quantity of light by polarizing and then retarding one component of the at least the one quantity of light relative to another component of the at least one quantity of light; (iv) directing the at least two quantities of energy generally toward the target so that the target is irradiated by the at least two quantities of energy, including directing the polarization state of any polarized energy generally toward the target in the instance where at least a portion of the energy is polarized; (v) analyzing a resulting polarization state for each of the first and second quantities of energy by retarding one component of the first and second quantities of energy following irradiation of the target relative to another component of the first and second quantities of energy, and then polarizing the retarded first and second quantities of energy; (vi) capturing a first image of the target irradiated by the first quantity of energy and a second image of the target irradiated by the second quantity of energy; (vii) optionally weighting at least one of the first and second images; and (viii) generating the multi-energy image of the target by evaluating a weighted difference between the first and second images, and/or by comparing and/or combining the first and second images, wherein the at least one dopant to enhance at least one detection characteristic of the target.

In one embodiment, the dopant for use in conjunction with above method is selected from, or contains, one or more polar molecules, one or more nanocomposites, one or more nanoparticles, one or more nanopolymers, one or more salts, one or more dipolar ions, one or more zwitterions, one or more ionic surfactants, one or more enzymes, one or more proteins, one or more amino acids, one or more high refractive index dielectric molecules, one or more macromolecules, one or more nanostructures, one or more fluorescent particles, one or more high index of refraction molecules, one or more polar and non-polar organic and inorganic macromolecules, one or more optically active molecules, one or more chiral molecules, one or more polymers, one or more copolymers, one or more nano-polymers, one or more biological block copolymers, one or more proteins, one or more enzymes, one or more peptides, one or more surfactants, one or more liquid crystal particles, or any suitable combination of two or more thereof.

In one embodiment, the above method involves the step of emitting the first and second quantities of energy wherein this process step comprises the step of: utilizing an energy source that has the ability to generate one or more wavelengths of energy in the gamma ray, X-ray, ultraviolet ray, visible, infrared ray, radar, and/or radio wave portions of the electromagnetic spectrum.

In another embodiment, the above method involves the step of creating an initial polarization state wherein this process step comprises the steps of: linearly polarizing the first and second quantities of energy; and then retarding at least one of the ordinary and extraordinary components of the linearly-polarized energy with a quarter-wave retarder to create a phase angle between the ordinary and extraordinary components.

In another embodiment, the above method involves the step of analyzing the resulting polarization state wherein this process step comprises the steps of: analyzing a resulting phase angle between the ordinary and extraordinary components of the first and second quantities of energy following interaction of the first and second quantities of energy with the target; and then linearly polarizing the first and second quantities of energy.

In another embodiment, the above method involves the step of weighting at least one of the first and second images wherein this process step comprises the steps of: determining a Mueller matrix for each of the first and second images; determining a weighting factor suitable for at least one of the first and second images; and changing at least one of the first and second images by the value of the weighting factor.

In still another embodiment, the above method involves the step of generating the multi-energy image of the target wherein this process step comprises the steps of: determining a difference between the at least one weighted image and the remaining image; generating a Mueller matrix for the difference between the two images; and displaying an image generated from the Mueller matrix for the difference between the two images.

### BRIEF DESCRIPTION OF THE DRAWINGS

FIG. 1 is a graphic illustration of one embodiment of the present invention;

FIG. 2 illustrates various macromolecules in water;

FIG. 3 illustrates a simplified guiding/focusing effect of the present invention;

FIG. 4 illustrates one embodiment of the present invention that is utilized in sensing applications;

FIG. 5 is an experimental setup according to one embodiment of the present invention;

FIG. 6 is a graph illustrating a light signal transmission through a water-filled lens at 830 nm;

FIG. 7 is a graph illustrating a light signal transmission through water+1 u Insulin at 830 nm;

FIG. 8 is a graph illustrating a light signal transmission through water+3 u Insulin at 830 nm;

FIG. 9 is a graph illustrating a light signal transmission through water+6 u Insulin at 830 nm;

FIG. 10 is a graph illustrating a light signal transmission through water+9 u Insulin at 830 nm;

FIG. 11 is a graph illustrating a light signal transmission through water+12 u Insulin at 830 nm;

FIG. 12 is a graph illustrating a light signal transmission through water+15 u Insulin at 830 nm;

FIG. 13 is a graph illustrating a light signal transmission through water+18 u Insulin at 830 nm;

FIG. 14 is a graph illustrating a light signal transmission through water+21 u Insulin at 830 nm;

FIG. 15 is a graph illustrating a light signal transmission through water+23 u Insulin at 830 nm;

FIG. 16 is a graph illustrating a light signal transmission through water+25 u Insulin at 830 nm;

FIG. 17 is a graph illustrating a light signal transmission through water+27 u Insulin at 830 nm;

FIG. 18 is a graph illustrating a light signal transmission through water+29 u Insulin at 830 nm;

FIG. 19 is a graph illustrating signal amplitude versus insulin concentration;

FIG. 20 is a graph illustrating signal amplitude versus water+insulin concentration and 90 nm gold nanoparticles mixed together where S₀ represents insulin concentration only while S₁ and S₂ represent water+insulin+increasing colloidal gold nanoparticle concentrations;

FIG. 21 is a graph illustrating a light signal transmission through water at 830 nm;

FIG. 22 is a graph illustrating a light signal transmission through water+0.2 ml Alcohol at 830 nm;

FIG. 23 is a graph illustrating a light signal transmission through water+0.4 ml Alcohol at 830 nm;

FIG. 24 is a graph illustrating a light signal transmission through water+1 ml Alcohol at 830 nm;

FIG. 25 is a graph illustrating signal amplitude versus alcohol concentration;

FIG. 26 illustrates a radiation scintillator based on the present invention;

FIGS. 27 and 28 illustrate various imaging applications based on the present invention;

FIG. 29 illustrates an optical communication device based on the present invention;

FIG. 30 illustrates a method by which to enhance the detection, imaging, and treatment of diseases based on present invention;

FIG. 31 through 33 illustrate various enhanced light principles and/or devices based on the present invention

FIG. 34 illustrates an exemplary reconfigurable photonic circuit using liquid metamaterials based on the present invention;

FIG. 35 illustrates enhanced detection of light based on the present invention;

FIG. 36 illustrates enhanced detection of light based on another embodiment of the present invention;

FIG. 37 illustrates PET tomography based on the present invention;

FIG. 38 is a diagram of the multispectral, multi-fusion, Stokes parameter/Mueller matrix spectral difference detection and imaging polarimetric principles;

FIG. 39 is a diagram of the physical principles of the multi-fusion, multi-spectral polarimetric image differences;

FIG. 40 is a diagram of the multi-fusion, multispectral polarimetric image differences system;

FIG. 41 is a S₀ Stokes parameter image of a microsphere, embedded at a skim milk-water solution, at 633 nm;

FIG. 42 is a S₀ Stokes parameter image of a microsphere, embedded at a skim milk-water solution, at 785 nm;

FIG. 43 is a S₀ Stokes polarization parameter image subtraction (785 nm to 633 nm);

FIG. 44 is a DOLP image of a microsphere, embedded at a skim milk-water solution, at 633 nm;

FIG. 45 is a DOLP Image of a microsphere, embedded at a skim milk-water solution, at 785 nm;

FIG. 46 is a DOLP Subtraction image of a microsphere, embedded at a skim milk-water (785 nm to 633 nm);

FIG. 47 is a √(S₁²+S₂²) subtraction image of a microsphere, embedded at a skim milk-water (785 nm to 633 nm);

FIG. 48 is a diagram of the DOLP polarimetric imaging system, utilizing high index of refraction molecular contrast agents;

FIG. 49 is a DOLP image of a phantom target, embedded into water;

FIG. 50 is a DOLP image of a phantom target embedded into high index of refraction-water concentration solutions (5 ml of water with 1.66×10⁻² moles/ml of CH₃CH(OH)CH₃), at 633 nm;

FIG. 51 is a DOLP image of a phantom target embedded into high index of refraction-water concentration solutions (5 ml of water with 0.049 moles/ml of CH₃CH(OH)CH₃), at 633 nm;

FIG. 52 is a DOLP image of a phantom target embedded into high index of refraction-water concentration solutions (5 ml of water with 0.11 moles/ml of CH₃CH(OH)CH₃), at 633 nm;

FIG. 53 is a backscattered DOLP image of a scattering phantom obtained through illumination of the target with a He—Ne 633 nm laser (scattering solution: 20 cc of water mixed with 0.7 cc skim milk);

FIG. 54 is a backscattered DOLP image of a scattering phantom obtained through illumination of the target with a He—Ne 633 nm laser (scattering solution: 20 cc of water mixed with 1.8 cc skim milk); and

FIG. 55 is a graphic detailing the options available for doped techniques.

### DETAILED DESCRIPTION OF THE INVENTION

The present invention generally relates to new photophysical characteristics associated with certain macromolecules, heterogeneous phases with a pronounced index of refraction contrast, and biological complex macromolecules. Given this, in one embodiment the present invention relates to new processes, methods and applications, for enhancing signals and images. In another embodiment, the present invention relates to the design and development of scalable imaging systems and techniques, optical instrumentation and lenses, systems engineering, photonics and optoelectronics, low-power microelectronics, micro-nanotechnology, and sensing/biosensing applications for various applications (e.g., life science applications).

In one instance, the present invention relies on generating, using, enhancing, and/or promoting heterogeneity between the liquid phases of two media, where one of these media exhibits a high molecular dipole moment and therefore a high molecular polarization thereby resulting in an increased index of refraction contrast between the two media. This in turn results in the creation of a photonic structure with metamaterial characteristics. This same concept can also be applied to more than two media.

In another instance, preliminary experimental studies performed by the inventor indicate that insulin molecules exhibit metamaterial-like characteristics and can be used to enhance, focus and amplify incoming light photon signals. Further signal amplification and enhancement has been observed by doping insulin molecules with colloidal gold nanoparticles.

This invention could lead to the development of novel photonic and biomolecular photonic materials, photonic nanocrystals, miniaturized, reconfigurable and scalable optical devices, detectors and sensors, lenses and super-resolution optical components, micro and nanofluidic systems, nanodevices, communication components and/or devices, and/or imaging systems, offering at the same time unique light control capabilities.

The above has been validated by the inventor through two different experiments: (1) in the first of the experiments, insulin molecules are embedded in a host medium (water) and exhibited distinct photonic crystal characteristics, thereby giving rise to high signal-to-noise ratios, enhanced focusing and amplification of incoming light photon signals, with increasing the concentrations of the insulin molecules. Indeed, moderately larger signal-to-noise ratios are observed by doping aqueous insulin molecules with colloidal gold nanoparticles; and (2) in the second of the experiments, larger detected signal-to-noise ratios are associated with light transmitted through aqueous alcohol solutions rather than through the water only.

In both examples, high polar dipole moments associated with the solutes in combination with a certain degree of heterogeneity of the liquid phase, contributes to the formation of highly reconfigurable photonic structures, with increased refractive index contrast.

The present invention can be utilized to develop novel materials and metamaterials, photonic nanocrystals, as well as devices and systems, such as miniaturized, reconfigurable and scalable optical devices, sensors, detectors, nanodevices, biomaterials, biomedical systems, communications, imaging systems, microelectronics, and/or various industrial and/or medical applications that offer, among other things, unique light control capabilities because, for example, the slowing down of light.

Giakos introduced novel target detection methodologies, where significant image enhancement is obtained by doping the surrounding background of targets of interest with optical active molecules, alone or in combination with nanoparticles (see, e.g., G. C. Giakos, Multi-fusion Multi-spectral Lightwave Polarimetric Detection Principles and Systems, IEEE Transactions on Instrumentation and Measurement, vol. 55, pp. 1904-1911, No. 6, December 2006; and G. C. Giakos, Novel Molecular Imaging and NanoPhotonics Detection Principles, IEEE International Workshop on Imaging Systems and Techniques, Niagara Falls, Canada, pp. 103-108, 2005). Based on this formalism, optical images acquired through doping of the background can yield superior imaging characteristics when compared to images obtained without doping a background. Some examples of optical active molecules (dopants) into the medium are: polar molecules such as, nanocomposites, nanoparticles, nanopolymers, salts, dipolar ions (zwitterions), ionic surfactants, enzymes, proteins, and amino acids, high refractive index dielectric molecules. For instance, doping liquids with polar molecules, or high index of refraction dielectric molecules alone, or in combination with other types of nanoparticles such as gold nanoparticles, gold nanoshells, and silver plasmon resonant particles, can boost both the image quality and introduce unique light manipulation capabilities such as light beam steering, focusing and shaping. In fact, enhanced light detection and target recognition has been achieved, using polarimetric imaging, in conjunction with optical active doping, by means of the following: (1) modulation of the “surrounding background” of the target or the target itself due to doping, so that a high contrast-to-background ratio results; (2) enhanced beam shaping and steering; and (3) reduction of light scattering and losses across the interface of two different dielectric media. In fact, these observations would lead to high-specificity early detection and effective tumor treatment techniques, capable of identifying the presence of precursor amino acids and enzymes in precancerous stage and treatment.

In one embodiment, the present invention relates to a process that utilizes the optical activity exhibited by any macromolecules, high index of refraction molecules, or polar macromolecules designed to amplify, modulate and/or enhance the electromagnetic and light wave signal characteristics through linear and non-linear mechanisms by providing unique signal characteristics, such as optical gain, high signal-to-noise ratio, light shaping, local refractive index tunability, brightness, high light intensity, enhanced focusing and depth of focus, spectrally tunable photoresponse, and optical control capabilities. Such macromolecules, high index of refraction molecules, or polar macromolecules suitable for use in the present invention include, but are not limited to, insulin, other globular proteins, hormones, organic molecules such as alcohol molecules in aqueous solutions or in any other matrix, and other macromolecules, like proteins, enzymes, salts (including zwitterions), milk molecules (including partial skim or skim milk) such as casein molecules, dipolar ions, polymers, copolymers, block-copolymers, and biological amphiphilic macromolecules, AB-block copolymer hybrid materials, and macromolecule aggregation products like high-molecular-weight polymers and/or cluster-like molecular heterogeneous, multi-phasic composite/nanocomposite structures or any combination of thereof in a suitable matrix (e.g., a liquid, gel, solid, gaseous or hybrid matrix). In this embodiment, the present invention also relates to multifunction capabilities where in addition to the above wave signal enhancement, the present invention can also enhance birefringence and polarization sensitivity, enhanced recognition, imaging, and bio-recognition molecular capabilities (e.g., the ability to sense, detect, bind, modulate, and/or recognize other target molecules).

In another embodiment, the present invention relates to a process that utilizes, generates, enhances, and/or promotes aggregation of macromolecules in the paragraph described above. Such macromolecules include, but are not limited to, proteins, enzymes, hormones, amino acids, bio-molecules, organic molecules, high index of refraction molecules, and polar macromolecules. In one instance the incomplete mixing of such molecules leads to the formation of heterogeneous phases with high polar dipole moments having a pronounced index of refraction contrast and local refractive index tenability which resemble multi-phasic composites, nano-composites or metamaterials. Interestingly enough, polymers in aqueous solutions can form structures made from hydrophobic (non-polar)-hydrophilic (polar) atoms that give rise to heterogeneous structure formation. As an example, the existence of hydrophobic pockets or cavities in bulk water, together to clathrates, all with different index of refraction, can give rise to the formation of nanocomposite structures with different indices of refraction. As a result, incident light can be modulated by, for example, a complex non-linear aqueous insulin structure thereby resulting in unique guiding, resonance, and local field effects when subjected to relatively large birefringence and correspondingly large refractive index tuning ranges. These multi-phasic molecular structures could amplify, modulate, guide, and/or enhance the electromagnetic and light wave signal characteristics through linear and non-linear mechanisms by providing unique linear and non-linear signal characteristics, such as optical gain, local refractive index tunability, high signal-to-noise ratio, light shaping, brightness, high light intensity, enhanced focusing and depth of focus, spectrally tunable photoresponse, and optical control capabilities. In the same embodiment, the present invention relates to multifunction capabilities where in addition to the above wave signal enhancement, one can also enhance birefringence and polarization, sensitivity, enhance recognition, enhance imaging, and enhance bio-recognition molecular capabilities (e.g., the ability to sense, detect, bind, modulate, and/or recognize other target molecules).

In another embodiment, the present invention relates to, a process that utilizes, generates, enhances, or promotes the formation of macromolecular and biological complex systems, or synthetic macromolecules, comprising the fusion of synthetic polymers with biopolymer segments with enhanced photophysical and multifunctional capabilities. Macromolecular and biological complex systems can be constructed by the ordering of polymer components such as polymers of amino acids, saccharides, nucleic acids, by combining covalent bonds and weak interactions (hydrophobic, hydrogen-bonding, polar and electrostatic interactions), and their photophysical characteristics can be controlled or manipulated by specific sequence compositions, and variation of the conductivity, local refractive index tunability, the concentration, aggregation enthalpy, fractal exponent conductivity pH, temperature, viscosity, insulin type or combination, chemical, physical, electrical, optical, electro-optical characteristics and/or the geometrical characteristics of the solvent or matrix. These multi-phasic molecular structures could amplify, modulate and/or enhance the electromagnetic and light wave signal characteristics through linear and non-linear mechanisms, by providing unique signal characteristics, such as optical gain, high signal-to-noise ratio, light shaping, brightness, high light intensity, enhanced focusing and depth of focus, spectrally tunable photoresponse, and optical control capabilities.

In the same embodiment, the present invention relates to multifunction capabilities where in addition to the above wave signal enhancement, the present invention can also enhance birefringence and polarization sensitivity, enhanced recognition, imaging, and bio-recognition molecular capabilities (e.g., the ability to sense, detect, bind, modulate, and/or recognize other target molecules). For instance, when common synthetic polymers are combined with biopolymer segments the resulting AB-block copolymer hybrid materials or aggregates can exhibit superior photophysical and multifunctional capabilities with enhanced photophysical and multifunctional capabilities for imaging, systems engineering, photonics and optoelectronics, low-power microelectronics, micro-nanotechnology, sensing/biosensing and life science applications.

In still another embodiment, the present invention relates to a process that utilizes insulin, proteins, polar molecules, high index of refraction molecules, amino acids, or alcohol macromolecules, and their aggregation products such as high-molecular-weight polymers and/or cluster-like molecular heterogeneous compositions in aqueous solutions or in other matrixes such as liquid, gel, solid, gaseous or hybrid matrices. These multi-phasic molecular structures could amplify, modulate and/or enhance the electromagnetic and light wave signal characteristics through linear and non-linear mechanisms, by providing unique signal characteristics, such as optical gain, local refractive index tunability, high signal-to-noise ratio, light shaping, brightness, high light intensity, enhanced focusing and depth of focus, spectrally tunable photoresponse, and optical control capabilities.

In the same embodiment, the present invention relates to multifunction capabilities where in addition to the above wave signal enhancement, the present invention can also enhance birefringence and polarization sensitivity, enhanced recognition, imaging, and bio-recognition molecular capabilities (e.g., the ability to sense, detect, bind, modulate, and/or recognize other target molecules).

In still another embodiment, the present invention relates to a method that enhances one or more physical, optical and/or signal characteristics of the fluorescence, bioluminescence, chemoluminescence, and/or any other spontaneous, or induced, photoemission mechanisms. This embodiment can also be used to yield enhanced light detection of the target.

In still another embodiment, the present invention relates to a method that can optically shape, focus, guide, provide local refractive index tenability, and amplify light. Thus, in one embodiment, the present invention makes possible a system where photo-thermal tumor ablation can be controlled. By changing the ratio between the hydrophobic and hydrophilic surfaces of an aqueous insulin or other macromolecular system, the present invention yields and/or produces, in one embodiment, a change in the index of refraction contrast and a local refractive index tunability.

In one embodiment, the methods of the present invention are accomplished by doping a background of a target, or the target itself, with macromolecules or polar macromolecules like insulin and alcohol molecules in aqueous solutions or in any other polar molecule and other macromolecules, like proteins, enzymes, peptides, hormones, dipolar ions, polymers, copolymers, block-copolymers, and biological amphiphilic macromolecules, AB-block copolymer hybrid materials, and their aggregation products like high-molecular-weight polymers and/or cluster-like molecular heterogeneous, multi-phasic composite/nanocomposite structures or any combination of one or more thereof in conjunction with one or more nanostructures, gold or other metal particles/nanoparticles, surface plasmon nanostructures, photomolecules, or any combination of one or more thereof.

In still another embodiment, the present invention relates to a method that utilizes one or more macromolecular dopants to further enhance the potential of detection process, imaging, multispectral imaging, fluorescence, microscopy, nano-instrumentation, spectroscopy and/or imaging.

All the above embodiments operate at the electromagnetic spectrum, as well at light frequencies from UV to IR. However, as an example, such processes could be used jointly with other radiation principles, such as laser-acoustics, nuclear medicine, MR, ultrasound, or any combination of them, as well as in combination with electrooptical, acoustoptical techniques.

The above invention and the deployment of polar dopants enhances the electromagnetic and optical interactions with matter leading to enhanced signatures fluorescence, bioluminescence, photoablasion, photothermal interactions, chemoluminescence, and/or any other spontaneous or induced photoemission mechanisms. Index of refraction contrast and local refractive index tunability could result in enhanced resonance or non resonance processes leading to higher light transmission yield, reflection, scattering, absorption, and polarization, depending upon the macromolecule of choice.

In all of the above-mentioned embodiments, further signal or other multifunctional capabilities enhancement can be enhanced by creating liquid, solid, hybrid, or gaseous matrices doped with macromolecules, polar molecules, nanoparticles, nanostructures, fluorescent particles including inorganic and organic quantum dots, high index of refraction molecules, polar and non-polar organic and inorganic macromolecules, optically active molecules, chiral molecules, polymers, copolymers, nano-polymers, biological block copolymers, proteins, enzymes, peptides, surfactants, liquid crystal particles, or any combination of them. The proposed invention has universal applicability under any state of matter. The macromolecular structures of the proposed invention can be used as a film, crystal, coating, gel, sol-gel, or membrane of any structure, state, or composition (i.e., polymeric membrane), evaporated or deposited, on any medium.

In all of the above-mentioned embodiments, signal enhancement and/or conditioning, as well as local refractive index tunability, and tunability and reconfigurability of the index of refraction contrast, can be achieved by, for example, varying the conductivity, the concentration, aggregation enthalpy, fractal exponent conductivity pH, temperature, viscosity, insulin type or combination, chemical, physical, electrical, optical, electro-optical characteristics and/or structure of the solvent, and presence of ions. Changing the ratio between hydrophobic and hydrophilic surfaces of multi-phasic composites by some perturbation will largely affect the arrangement and flexibility of water molecules, an enhanced index of refraction contrast results, giving rise to local field enhancement and significant gain due to nonlinear effects, as well as enhanced photon tunability.

In all of the above-mentioned embodiments, the present invention relates to the development of high resolution, high contrast, high-specificity imaging systems, bio-molecular and molecular photonic materials, optical devices (e.g., optical filters, polarization devices, lab-on-a chips, sensors, phase shifters, optical amplification, optical lenses, and super-resolution systems), high-efficiency optical catheters and endoscopes, high-efficiency light-guides, optical beam shaping, sensors, communication systems, design of nano-microstructures, nano-devices, biomedical systems, scalable and reconfigurable catheters, guiding structures, therapeutic applications, advanced imaging systems with enhanced polarimetric functions, microelectronics, and/or various industrial, environmental monitoring/detection, immunoassays, pharmaceutical, biological, and/or medical applications (e.g., drug delivery, detection of diseases, diagnosis, and pathology, medicines, efficient environmental monitoring, and spectroscopic devices, photodynamic treatment, diagnostic, analytical, medicines, photomedicines, and therapeutic applications).

As an example, doping water-filled light guide structures with insulin, alcohol, milk or skim milk (casein micelles), or the molecular structures discussed above, or any combination thereof can lead to enhanced light signal detection, improved imaging of the light guide structures, enhanced contrast of target embedded into those structures, as well as high-intensity light beam profile. If combined with polarization control, on both the receiver and the receiver, enhanced signal characteristics and polarization could result, setting the principles of new catheter and light guiding design principles for a variety of applications. Most of this macromolecular structures exhibit multifunctional capabilities, in the sense that they can both contribute towards the design of efficient instruments as well as contribute to new diagnostic methodologies for disease diagnosis and assessment. For instance, differential diagnosis of disease, such as Alzheimer disease or diabetes, could be possible, by assessing the presence of extracellular amylin in brain or pancreatic tissue, respectively, based on the development of efficient immunoassays or efficient polarimetric techniques, using various techniques disclosed herein.

Additionally, by carefully selecting from the molecular structures disclosed above, such structures could be utilized to develop efficient spectral and polarimetric imaging sensors capable of performing spectral and polarimetric filtering within the detector elements or pixels, enhanced polarization sensitivity (high extinction ratio) and scalability, with the selectivity performed inherently by the material optical characteristics. In another instance, these molecular structures could interfere with coherent scattering of low-energy x-rays thereby giving rise to enhanced coherent scattering images. Therefore, enhanced image contrast based on the metabolic content of a biological structure would result. In another instance, mixing suitable molecular structures discussed above into x-ray, neutron, and gamma ray scintillation detectors can enhance the scintillations per se. As another example, during surgical operations or laparoscopic procedures, the physician may inject (administer) solutions containing macromolecules discussed above into a target of interest, or into the flushing water, in addition to one or more medications, so as to achieve a high image contrast and a better field of view (FOV) due to the local enhancement introduced by the local refractive index tunability. A micro-fluidic system in conjunction to a macromolecular delivery system should assure selective local refractive index tenability and therefore real-time images of high selectivity, specificity and contrast.

The above embodiments disclose unique principles and ideas applied both in macroscopic and microscopic domains for image contrast enhancement in conjunction with polarimetric imaging systems by, among other things, introducing local refractive index tunability. These ideas are presented in a structural approach. First, one must consider a background medium with an index of refraction n₁ surrounding a target of interest with an index of refraction n₂. This medium can be optically active or not-active and can be liquid, solid, or gas. Next, the introduction of any optically active molecules (dopants) as described above into the medium, modifies the optical properties of the medium. In addition, these optical active molecules (dopants) could act alone, in any combination thereof, or in conjunction with nanostructures, gold particles, quantum dots, organic fluorophores, contrast agents, biomarkers, reporters, surface plasmon nanostructures and/or photomolecules. These dopants, or any combination described above, can bind to a target media such as nanoparticles/nanostructures, tumors, antigens, fluorophores, quantum dots, proteins, amino acids and may form more complex polar molecular structures with distinct/high specificity, marking/contrast features.

Additionally, one must also consider the following points. The dopants inside the medium (background) cause the refractive index of the medium to become a volume weighted average between refractive indexes of nanoparticles and the phase of the medium, thus giving rise to an amplification of the index of refraction. As a result, a large index of refraction difference between the target and the surrounding medium (background) is obtained. In addition, the target itself can be doped, thereby modifying its surface, or by using the any of the dopants discussed above by doping both the surrounding medium and the desired target, or targets.

Another example of the present invention involves an incident electromagnetic field (EM) field, Terahertz (THz) field, or light field, on a doped medium that has been doped with one or more of the dopants discussed above thereby resulting in a modification the medium's physical/optical characteristics.

Another method of the present invention involves an incident polarizing EM field, THz field, or light field on a doped medium that has been doped with one or more of the dopants discussed above thereby resulting in a coupling of its polarization with the dipole moment of the polar dopant. Another method of the present invention involves an incident polarizing EM field, THz field, or light field on such doped medium that has been doped with one or more of the dopants discussed thereby resulting in a rotation of polarization.

Another method of the present invention involves an incident polarized (linear) EM field, THz field, or light field on such doped medium that has been doped with one or more of the dopants discussed above, that could change the molecular orientation, due to an induced dielectric torque. Another example of the present invention involves an incident polarized (circular) EM field, THz field, or light field on such doped medium that has been doped with one or more of the dopants discussed above, that imparts a torque on the molecule by a transfer of angular momentum that drives the molecule to process. In these examples molecules exhibit a coupling of their electric dipole with the optical field, due to pseudo Stark effects and local field enhancement.

A result of the modulation discussed above, the surrounding background of the target with such dopants is a high contrast-to-background ratio, ideally observed (detected) using optical polarimetric imaging/detection principles. Another result of the present invention and the resulting modulation discussed above of the surrounding background of the target with the dopants, using one or more application-dedicated polar dopants discussed herein and high contrast-to-background ratios, results in high target specificity.

Another result of the modulation of the surrounding background of the target with dopants, as discussed herein, involves enhanced light beam shaping, modulation, focusing, depth of focus, and steering. One result of the modification of the surrounding background of the target with dopants in accordance with the present invention, is the reduction of light scattering and losses across the interface of two different dielectric media. Also of note here, is that the coupling of the optical field with dc fields leads to enhanced Stark effects and detection characteristics.

One application of the doping media discussed above can lead to the development of RF/THz/optical antennas and sensors, including macroscopic (bulk), microscopic and nanoscopic regimes. Another application involves the modulation of a background using various dopants, methods and procedures discussed above, that enhance the physical, optical and signal characteristics of the fluorescence, bioluminescence, chemoluminescence, and/or any other spontaneous or induced photoemission mechanisms, yielding to enhanced light detection and target definition.

By using the methods discussed above, and by selectively doping areas surrounding tumor cells with dedicated high-index of refraction nanoparticles and polar molecules, one can create pronounced resonance effects and local field effects thereby permitting the selective diagnosis and/or treatment of diseases via optical techniques.

The use of dopants in accordance with the present invention further enhances the potential of polarimetric detection and spectral imaging. Therefore, the use of dopants in conjunction with spectral-polarimetric detection/imaging techniques provides excellent results and an area for additional gains, contributing effectively towards the detection and imaging of specific molecular signatures in vivo providing physiological and metabolic information at the molecular level. The use of dopants can also generate high-specificity detection techniques capable to identify the presence of precursor amino acids and enzymes in disease, could lead to early disease detection, and treatment.

Optical modalities, utilizing one or more of the dopants discussed above, could be deployed in conjunction to x-ray systems, ultrasound, MRI and nuclear medicine systems (PET, SPECT), microscopy and nano-imaging, single-mole detection microscopy, confocal microscopy, and raman spectroscopy (scattering), towards the detection and imaging of specific molecular signatures in vivo providing physiological and metabolic information at the molecular level. In addition, concominant deployment of optical dopants during MRI interrogation could enhance the detection process. Similarly, concomitant employment of optical dopants in accordance with those discussed above during PET tomography, could enhance the metabolic activities of the areas of interest, alone, or jointly with other PET contrast agents. It could also enhance the potential of the PET contrast agents.

Optical dopants could be administered by inhalation, orally, intravenously, or by other any other suitable means. Once at the site of interest, they could be triggered either by the incident light beam or electromagnetic radiation alone, or by other means such as electrooptical, acoustooptical, or other physical/chemical techniques. Therefore, such methods could enhance the potential of, as well as lead to the development of new photosensitizers, photomedicine drugs, or photomedicine techniques, for therapeutic or diagnostic purposes.

In one embodiment, the present invention deals with the discovery, development and use of macromolecular and biological complex systems with enhanced photophysical and multifunctional capabilities for imaging, system engineering, photonics and optoelectronics, low-power microelectronics, micro-nanotechnology, sensing/biosensing and life science applications.

The interaction of macromolecules and biological material with light integrates major technologies such as photonics, nanotechnology, and to biotechnology, and is leading to new research frontiers such as molecular phonics and molecular nanophotonics. These emerging frontiers are promising to a large spectrum of disciplines such as medicine, biology, bioengineering, advanced diagnostic and analytical devices and instrumentation, including nano-instrumentation, defense, and homeland security. Photonic crystals are appealing for controlling light wave propagation by introducing pre-engineered defects into an otherwise regular lattice to create spectral filters, tight bend waveguides, resonant cavities, and highly efficient lasers. In general, many photonic structures are composed of two or more dielectrics. The absolute value of the refractive index contrast is important to the performance of such materials. For instance, porous photonic crystals that are filled with water and organic dyes have been reported in F. Intonti, et al., Microfluidics and Photonic Crystals may Yield Optical Integrated Circuits, Laser Focus World, January 2007.

Accordingly, increasing the index contrast between such materials would therefore be very desirable. Photonic crystals can be viewed as a subclass of a larger family of material systems called metamaterials in which the properties largely derive from the structure rather than from the material itself. Metamaterials, an extension of the concept of artificial dielectrics, typically consist of periodic structures of a guest material embedded in a host material. Distinct feature of metamaterials is that they facilitate the delivery of optical gain media, nonlinear liquids, and/or colloidal nanoparticles (e.g., gold nanoparticles). The optimization of component materials and geometries can yield metamaterials with unique optical properties, which allow such metamaterials to control light in unconventional ways with potential applications in photonic integration.

Electric polarization may be defined as the electric field induced disturbance of the charge distribution in a region. This polarization does not occur instantaneously, and the associated time constant is called the relaxation time τ. The relaxation of electrons and small dipolar molecules is a relatively fast process, with relaxation times in the pico- and nanosecond range, while interfacial polarization could give relaxation times of the order of seconds.

The development of macroscopic and nano-instrumentation imaging systems and techniques, capable to provide molecular, biochemical, physiological, and metabolic information for medical and biological applications is of paramount significance. Although, contrast agent-based techniques have been widely for x-ray imaging applications, such as angiography, gastrointestinal (GI) endoscopy, nuclear medicine, and paramagnetic particles, however, no contrast enhancement techniques have been developed yet for bulk optical detection and imaging, besides the use of optical nanostructures and fluorophores for dedicated nano-microscopy applications.

Optical imaging provides a detailed description of biological tissues. For instance, it allows the characterization of a variety of diseases, such as breast cancer, skin cancer, lung cancer, cancer of the bladder, and the analysis of molecular pathways leading to diseases. In addition, optical polarimetry, provides enhanced imaging and spectral polarimetric information regarding the metabolic information of the tissue, as well as the molecular mechanism of a biological function, drug-cell interaction, single-molecule imaging, and so on. Image formation through detection of the polarization states of light offers distinct advantages for a wide range of detection and classification problems, and have been explored by a number of authors, due to the intrinsic potential of the optical polarimetry to offer high-contrast, high-specificity images under low-light conditions.

As discussed above, Giakos introduced novel target detection and imaging methodologies, with tremendous applications in areas of photonics and nanophotonics, where contrast enhancement of the target has been be obtained by doping the background surrounding the target or the target itself with optical active molecules, alone or in combination with nanoparticles, in conjunction with polarimetric imaging techniques. Some examples of optical active molecules (dopants) into the medium are polar molecules such as, nanocomposites, nanoparticles, nano-polymers, salts, dipolar ions (zwitterions), ionic surfactants, enzymes, proteins, and amino acids, high refractive index dielectric molecules. In fact, an enhanced light detection and target recognition has been achieved, using polarimetric imaging, by means of the following: (1) modulation of the “surrounding background” of the target or the target itself, due to the doping, so that a high contrast-to-background ratio results; (2) enhanced beam shaping and steering; and (3) reduction of light scattering and losses across the interface of two different dielectric media.

Again as is discussed above, optical imaging and target detection and identification, through scattering media, although an emerging technology, have been explored by a number of authors. Optical polarimetry relies on polarimetric information obtained through backscattered light from the target, while offering distinct signatures related to the target geometry, structure, and composition. Specifically, the polarization of the scattered light depends upon a number of geometrical, physical, chemical, physiological, and metabolic parameters, such as incident polarization state, surface smoothness, shape, size, color, orientation, and concentration of the scatter, as well as from the optical properties of the scatter, such as refractive indexes of the scatter, molecular structure, biochemical, physiological and metabolical functions of the target and the surrounding medium. Imaging formation through detection of the polarization states of light offers distinct advantages for a wide range of detection and classification problems, and have been explored for biomedical applications by a number of authors, due to the intrinsic potential of the optical polarimetry to offer high-contrast, high-specificity images under low-light conditions.

By referring to the early cancer detection and treatment, it is well established that, one factor contributing to inaccurate staging and treatment assessment of cancer is the use of low-contrast or unreliable imaging procedures. Conventional x-ray imaging systems produce images based on the structure of the tissue; and thus, the resulting signal provides only anatomical information, without any physiological or metabolic signature. Indeed, ultrasound imaging, magnetic resonance imaging (MRI), and computed tomography imaging (CT) rely basically on the ability to differentiate the tumor against the surrounding tissue and inherent background noise. As a result, they can produce signals with little sensitivity or specificity. Therefore, more sensitive and specific imaging, utilizing the above mentioned dopants, can play an important role in the diagnosis and treatment of cancer. Better imaging allows diagnosis and therapy to be addressed selectively to the tumor, and can be used to better facilitate localized surgical interventions, such as ablation, endoscopy, and lumpectomy, that allow limited diseased areas to be treated more drastically. Better imaging can also facilitate minimally invasive monitoring of therapeutic response.

As a result, the use of dopants in conjunction with polarimetric detection/imaging techniques provides excellent results and an area for additional gains and contributes effectively towards the detection and imaging of specific molecular signatures in vivo providing physiological and metabolic information at the molecular level. The main issue encountered in molecular detection involves achieving a sufficiently high signal-to-noise ratio so that weak fluorescence from one individual molecule can be distinguished from the background. One example involving the imaging of the molecular features of cancer shows that it is necessary to deliver a sufficient contrast agent to the tissue so that an adequate signal-to-noise ratio can be achieved. Near-field microscopy allows significant strides to be made in achieving this goal: Examples include methods such as quantum dots, up-converting nano-phosphors, encapsulated dyes, plasmonic nanostructures, and, dye-doped nanoparticles, as are all promising optical contrast agents for bio-imaging, bio-detection and similar areas of technology.

Insulin crystals which are highly polar in aqueous or liquid solutions are made from hydrophobic (non-polar)-hydrophilic (polar) atoms giving rise to islets of different indices of refraction, forming heterogeneous, nonlinear cluster-like media. During insulin aggregation, high-molecular-weight polymers/molecular cluster aggregates take place, leading to heterogeneous molecular formation with enhanced high polar dipoles and dominant interfacial processes. Similarly, the entropy of a system consisting of alcohol molecules, such as for instance, methanol or ethanol, mixed with water is increased at a reduced extend when compared to an ideal solution of randomly mixed molecules. This suggests that the anomalous thermodynamics of water-alcohol systems arises from incomplete mixing at the molecular level and from retention of remnants of the three-dimensional hydrogen-bonded network structure of bulk water. Interestingly enough, this is attributed to hydrophobic head groups creating ice-like or clathrate-like structures in the surrounding water, although experimental support for this hypothesis is scarce. As a result, hydrophobic head groups of alcohol molecules in aqueous solution cluster together with most of the water molecules existing as small hydrogen-bonded strings and clusters in a fluid of close-packed methyl groups; on the other hand, water clusters bridge neighboring methanol hydroxyl groups through hydrogen bonding.

During molecular aggregation high-molecular-weight polymers/molecular cluster aggregate form leading to heterogeneous molecular formation with enhanced high polar dipoles and dominant interfacial processes, as well as to non linear phenomena, and enhanced anisotropic effects, contributing significantly to the enhancement of the electrical/optical properties of the macromolecules and its surroundings (background). As a result light waves can experience enhanced signal characteristics in addition to enhanced multifunctional capabilities such as birefringence and polarization sensitivity, enhanced recognition sensing, and binding of target molecules. Changing the ratio between hydrophobic and hydrophilic surfaces of multi-phasic composites by some perturbation will largely affect the arrangement and flexibility of liquid (water) molecules, an enhanced index of refraction contrast results, giving rise to local field enhancement and significant gain due to nonlinear effects, as well as enhanced photon tunability.

The distinct photophysical characteristics can be lead to amplify, modulate and/or enhance the light wave signal characteristics by providing unique signal characteristics and bio-recognition capabilities, such as optical gain, light shaping, spectrally tunable photo-response, and optical control capabilities as well as to non linear phenomena, and enhanced anisotropic effects, contributing significantly to the enhancement of the electrical/optical properties of the macromolecules and its surroundings (background).

Macromolecular and biological complex systems can be constructed by the ordering of polymer components such as polymers of amino acids, saccharides, nucleic acids, by combining covalent bonds and weak interactions (hydrophobic, hydrogen-bonding, polar and electrostatic interactions), with photophysical characteristics controlled or manipulated by specific sequence compositions, and variation of the conductivity, the concentration, aggregation enthalpy, fractal exponent conductivity, pH, temperature, viscosity, insulin type or combination, chemical, physical, electrical, optical, electro-optical characteristics and/or the geometrical characteristics of the solvent or matrix.

Furthermore, the concepts discussed above can lead to the development, deployment and applications of unique synthetic biopolymer macromolecules with enhanced photophysical and multifunctional capabilities, which resemble the structure and morphology of biological systems, but that possess the versatility in compositions and properties that exists or synthetic materials. For instance, combining common synthetic polymers with various biopolymers segments the resulting AB-block copolymer hybrid materials or aggregates can exhibit superior photophysical and multifunctional capabilities.

Examples of various concepts discussed above can be validated by two different experiments: (1) in the first of the experiments, insulin molecules are embedded in a host medium (water) and exhibited distinct photonic crystal characteristics, thereby giving rise to high signal-to-noise ratios, enhanced focusing and amplification of incoming light photon signals, with increasing the concentrations of the insulin molecules. Indeed, moderately larger signal-to-noise ratios are observed by doping aqueous insulin molecules with colloidal gold nanoparticles; and (2) in the second of the experiments, larger detected signal-to-noise ratios are associated with light transmitted through aqueous alcohol solutions rather than through the water only.

Thus, in one embodiment the present invention relates to polar macromolecules and formation of high-molecular-weight polymers and/or cluster-like molecular heterogeneous structures, through aggregation, resembling composite, nano-composite or metamaterial structures characteristics, with enhanced high polar dipoles and dominant interfacial processes, pronounced non linear phenomena, and enhanced anisotropic effects, contributing significantly to the enhancement of the electrical/optical properties of the macromolecules and its surroundings (background). As a result, enhanced incident wave signal characteristics result with enhanced multifunctional capabilities such as enhanced birefringence, polarization sensitivity and molecular recognition/bio-recognition capabilities.

The investigation of the three dimensional structure of a protein molecule is essentially important in many fields of science, such as biology, engineering, optics, nanotechnology, biochemistry, medicine, pharmacology and drug design.

The aggregation of proteins from aqueous solution is a phenomenon of growing importance in several fields of biosciences, among them biotechnology, pharmacy, and medicine. Insulin aggregation remains a fundamental obstacle to the long-term application of many insulin infusion systems. The effects of physiologic and non-physiologic compounds on the aggregation behavior of crystalline zinc insulin (CZI) solutions have been explored in a number of studies. As aggregation may have many reasons normally related to complex protein—protein interactions, it is not easy to develop a unifying theory which would cover all aspects of this phenomenon.

Although a lot of efforts are made to understand the mysterious mechanisms of proteins aggregation that tend to destabilize the chemical structures of protein-based pharmaceuticals such as insulin, no reverse engineering concepts have been explored that could utilize these detrimental mechanisms towards the generation of new scientific advances, inventions, and innovative paradigms. It is well known that insulin tends to produce aggregates that cause problems to diabetic patients. More stable hexamers led to the development of intermediate or slow-acting insulins. As a result, significant efforts have been addressed towards the knowledge of mechanisms of protein crystals growth of good quality without deposition of and microcrystal “free”, which introduce defects on the crystal.

Interestingly enough, hexamers in aqueous solutions form structures made from hydrophobic (non-polar)-hydrophilic (polar) atoms giving rise to heterogeneous structure formation. Water molecules can occupy 30% of the crystal unit cell and can exist under ordered water structure, divided in four groups, as well as under disordered water structure. The existence of hydrophobic pockets, or cavities, in the water, together with clathrates, give rise to formation of nanocomposite structures which can be treated as “defects”. In fact, water at a hydrophobic surface covers the surface with clathrate-like pentagons, so avoiding the loss of most of the hydrogen bonds.

Similarly, aqueous solutions of alcohol, exhibits anomalous thermodynamics of water-alcohol systems due to incomplete mixing at the molecular level and from retention of pockets of the three-dimensional hydrogen-bonded network structure of bulk water attributed to hydrophobic head groups creating ice-like or castrate-like structures in the surrounding water. Clathrates or clathrate compounds or cage compounds are weak composites comprising a lattice of one type of molecule trapping and containing a second type of molecule. For instance, a clathrate hydrate involves a special type of gas hydrate that comprises water molecules enclosing a trapped hydrogen molecule.

Again, similar to the previous case, castrate-like structures have a strong tendency to agglomerate and therefore have always been treated as annoying for the vast majority of technological applications giving rise to the formation of heterogeneous aggregated polar and nonpolar macromolecules. In contrast, the present invention favors the development of clathrate-like or cage structures, filled with different index of refraction water, since such structures enhance a “lensing” and/or guiding effects of the incident photons. Changing the ratio between hydrophobic and hydrophilic surfaces of multi-phasic composites by some perturbation will largely affect the arrangement and flexibility of water molecules thereby resulting in an enhanced index of refraction contrast. This in turn gives rise to local field enhancement and significant gain due to nonlinear effects as well as enhanced photon tunability.

The paradigms of insulin and alcohol molecules, in a liquid matrix, give rise to the formation of high polar, high molecular-weight polymers, cluster-like molecular heterogeneous structures and eventually to crystalline formation structures.

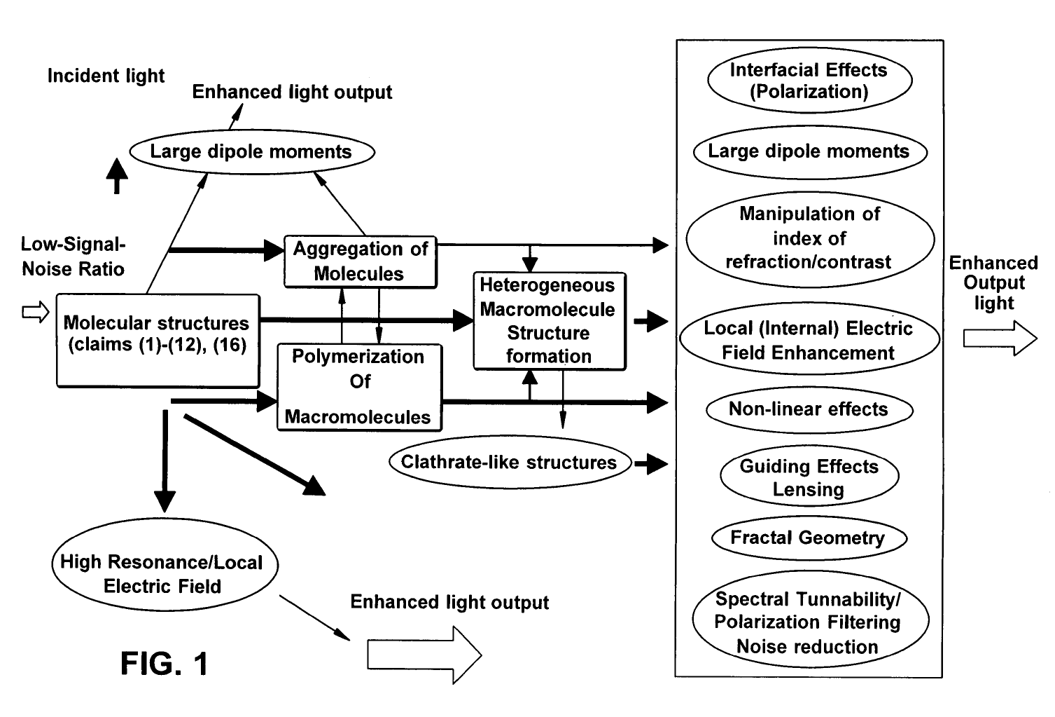

Reverse engineering implies the exploration of the unique electrooptical, physical, and geometrical characteristics of these phenomena. Therefore, one embodiment of the present invention is detailed in FIG. 1.

### The Insulin-Water Model and Generalization:

The molecular dipole moment (μ) of a monomer insulin molecule, is 72 D at 25° C., while, its molecular weight is 5300. In addition, insulin possesses a markedly lower quantity of water of hydration than has been observed for globular proteins containing a higher proportion of hydrophilic groups on the surface of the molecule. Thus, based on Equation 3 below, larger molecular weight insulin aggregates result in still larger values of μ. The molecular weight of myoglobin is 17000 with a molecular dipole moment of 158 D, while ribonuclease has a molecular weight of 13700 and a molecular dipole moment of approximately 350 D.

Based on reported studies, at least two kinds of water structures are found in a protein crystal, namely: (a) an ordered water structure; and (b) a disordered water structure. Many of the ordered water molecules are located on the surface of protein and can be divided into four groups: (i) water molecule adjacent to non-polar surface atoms; (ii) water molecule hydrogen bonded to polar groups; (iii) water molecule facing groups carrying a formal charge; and (iv) water molecule surrounded by water molecules only.

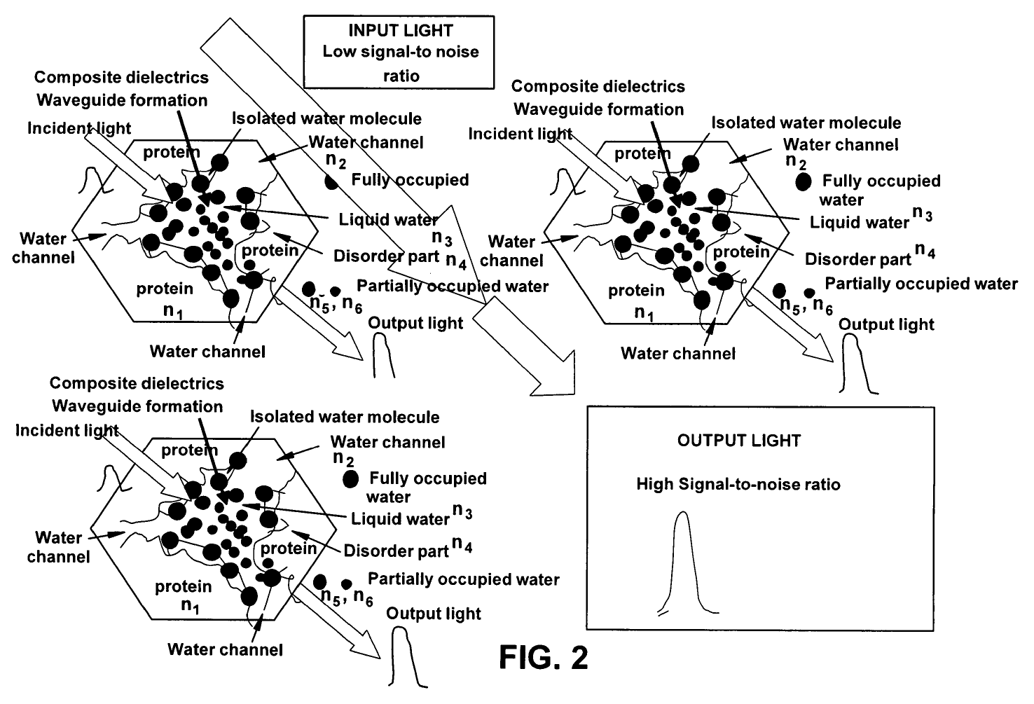

Water at a hydrophobic surface covers the surface with clathrate-like pentagons in partial dodecahedra, so avoiding the loss of most of the hydrogen bonds. This necessitates an expanded low-density local structure. Therefore, this can result in an insulin crystal possessing heterogeneous, nonlinear characteristics when “in” water or aqueous/liquid solution. This situation is illustrated in FIG. 2.

In FIG. 2 the heterogeneity of polymer insulin/proteins or other macromolecules, i.e., bio-molecules/polymer organic molecules, in water, is depicted. Clathrate-like or cage structures, filled with different index of refraction water or liquids, since enhances a “lensing”, non-linear effects, spectral filtering, index of refraction contrast enhancement, and guiding effects of the incident photons. An insulin crystal or macromolecules with similar characteristics, behaves like a reconfigurable photonic crystal, a nanocomposite, with metamaterial characteristics. Its structure is made from hydrophobic (non-polar)-hydrophilic (polar) atoms giving rise to islets of different indices of refraction.

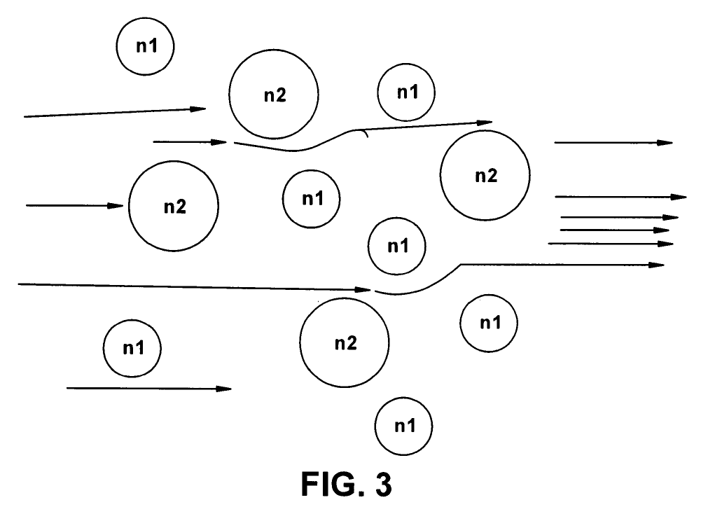

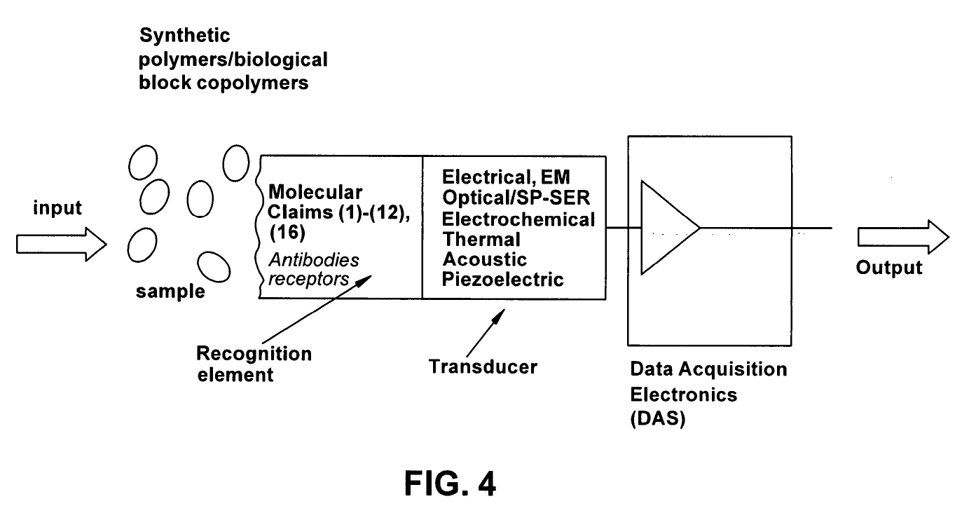

Accordingly, this can yield one or more metamaterials. As a result, incident light can be modulated by the complex non-linear aqueous insulin structure thereby resulting in unique guiding, resonance, and local field effects when subject to relatively large birefringence and correspondingly large refractive index tuning ranges. Further tunability and reconfigurability can be obtained by introducing a disturbance into the ratio between hydrophobic and hydrophilic surfaces. Changing the ratio between hydrophobic and hydrophilic surfaces of multi-phasic composites by some perturbation will largely affect the arrangement and flexibility of water molecules, an enhanced index of refraction contrast results, giving rise to local field enhancement and significant gain due to nonlinear effects, as well as local refractive index tunability, and enhanced photon tunability. Incident light gets modulated (e.g., focused, amplified, beam shaping, etc.) as it passes through the heterogeneous aqueous insulin crystal. A more simplified illustration of FIG. 2 is illustrated in FIG. 3.

Therefore, light propagating through this metamaterial-like structure exhibits guiding, amplification, focusing, and self-focusing effects. The absolute value of the refractive index contrast is important to the performance of the photonic system. Thus, increasing the index contrast would therefore be extremely useful in shaping, amplifying focusing and/or DOF variation, as well as modulating the light by controlling and/or enhancing the timing, spectral, frequency response of a system.

Further tunability and reconfigurability can be obtained by introducing a disturbance in the ratio between the hydrophobic and hydrophilic surfaces. Changing the ratio between hydrophobic and hydrophilic surfaces by some perturbation such as dimer/polymer formation yields a change in the arrangement and flexibility of water molecules thereby giving rise to enhanced tunability and reconfigurability due to the index of refraction contrast change. A change in the ratio between the hydrophobic and hydrophilic surfaces can be accomplished by modulating, solution concentration, PH, physical-chemical conditions, enthalpy, optical parameters, electrical parameters, electro-optical parameters, and/or by means of any linear and nonlinear mechanism. Furthermore, changing the ratio between hydrophobic and hydrophilic surfaces of multi-phasic composites by some perturbation will largely affect the arrangement and flexibility of water molecules, an enhanced index of refraction contrast results, giving rise to local field enhancement and significant gain due to nonlinear effects, as well as enhanced photon tunability.

Similarly, although the small alcohol molecules are completely soluble in water, their solubility falls as the length of the hydrocarbon chain in the alcohol increases. Therefore, for large hydrocarbon chains in alcohol the ratio between hydrophobic and hydrophilic surfaces changes thereby giving rise to enhanced index of refraction contrast due in one instance to heterogeneity. In addition, anomalous thermodynamics of water-alcohol systems occurs due to incomplete mixing at the molecular level and from retention of remnants of the three-dimensional hydrogen-bonded network structure of bulk water. Interestingly enough, this is attributed to hydrophobic head groups creating ice-like or clathrate-like structures in the surrounding water, although experimental support for this hypothesis is scarce. As a result, hydrophobic head groups of alcohol molecules in aqueous solution cluster together, with most of the water molecules existing as small hydrogen-bonded strings and clusters in a fluid of close-packed methyl groups; on the other hand, water clusters bridge neighboring methanol hydroxyl groups through hydrogen bonding. The anomalous thermodynamics of water-alcohol systems make these systems behave like metamaterials. By definition, metamaterials can be considered materials that are either in a thermodynamically meta-stable state or an unstable state.

The insulin and alcohol molecule example can be also expanded in a more general approach by searching or engineering other molecules exhibiting similar or better enhanced metamaterial characteristics. For instance, bio-inspired block copolymers are one example. Further tunability and reconfigurability can be obtained by introducing a disturbance in the ratio between hydrophobic and hydrophilic surfaces.

In both experiments, formation of high-polarity, high molecular-weight polymers and/or cluster-like molecular heterogeneous structures, in liquid matrixes, of incomplete mixing, resembling composite, nano-composite or metamaterial structures characteristics, with enhanced high polar dipoles and dominant interfacial processes, took place, giving rise to large signal-to-nose ratio, with increasing concentrations of insulin or alcohol molecules in water.

The above insulin and alcohol molecule example can be also expanded in a more general approach by searching or engineering other molecules, or composite materials exhibiting similar or better metamaterial like characteristics. For instance, macromolecular and biological complex systems can be constructed by the ordering polymer components such as polymers of amino acids, saccharides, nucleic acids, by combining covalent bonds and weak interactions (hydrophobic, hydrogen-bonding, polar and electrostatic interactions), with photophysical characteristics controlled or manipulated by specific sequence compositions, and variation of the conductivity, the concentration, aggregation enthalpy, fractal exponent conductivity pH, temperature, viscosity, insulin type or combination, chemical, physical, electrical, optical, electro-optical characteristics and/or the structure of the solvent, added ions, or matrix.

In one embodiment, the present invention proposes the development and uses of synthetic biopolymer macromolecules with enhanced photophysical and multifunctional capabilities which resemble the structure and morphology of biological systems, but that possess the versatility in compositions and properties that exists or synthetic materials. For instance, combining common synthetic polymers with biopolymer segments the resulting AB-block copolymer hybrid materials or aggregates can exhibit superior photophysical and multifunctional capabilities.

### High Polar Dipoles:

It appears that the electric behavior of water-based or liquid-based solutions of insulin, as with other globular proteins, and alcohol molecules mixed to the water, can be accounted for by the rotation of permanent dipoles.

The first important characteristic of a protein or a polar macromolecule is that in solutions produce remarkably large increments in the dielectric constant of water. These increments are attributed to large permanent dipole moments, which are partially oriented by an external electric field. The applied torque, τ, is given as:

τ=q L̅×Ē (1)

where q is the charge, L is the separation distance, and E the applied electric field. For liquid solutions of high dielectric constant, the dielectric constant D and the molar polarizations Pⱼ of the several components are given as:

$$\begin{matrix}D = 1 + \frac{9}{2 } {\sum }_{j} {P}_{j} & ( 2 ) \\ {P}_{j} = \frac{4 π N}{3} [ {α}_{j} + < {μ}_{j}^{2} {>}_{av} / 3 kT ] & ( 3 )\end{matrix}$$

respectively, where αⱼ is the optical polarizability and <μⱼ²>ₐᵥ is the mean square of the dipole moment of a molecule of type j.

The above equations suggest that the polarization, and thus the dielectric properties of the macromolecules, is conditioned by the mechanism of rotation of the permanent dipoles.

The relaxation time, τᵣ, is offered through the Debye relationship as:

$${τ}_{r} = 4 π {a}^{3} \frac{n}{kT} \qquad ( 4 )$$

Where a is the radius of the rotating molecule, n is the viscosity of the medium, k is Boltzmann constant, and T is temperature.

The molecular dipole moment of the insulin can be expressed as:

$${μ}^{2} = \frac{2 kT {ɛ}_{0} M}{N} \frac{Δ}{C} \qquad ( 5 )$$

where M is the molecular weight, N is the Avogadro number, and C is the concentration of the solution in Kgm⁻³.
Effects of the Increased Concentrations of insulin and Alcohol Molecules into the Water:

Increasing the concentration of insulin or alcohol in solution results in an increase in the aggregation and thereby results in molecules of larger molecular weight and molecular dipole moments. As a result, molar polarization and the dielectric constant of the aqueous insulin solution increase. Equivalently, tenability and reconfigurability can be obtained by introducing a disturbance in the ratio between the hydrophobic and hydrophilic surfaces of the insulin crystal.

### High Local Electric Field:

By careful selection of the indices of refraction of the two media, one can enhance the local field to produce significant gain in the nonlinear optical effects. Similarly, the increase of the polar dipole moment has a direct effect on the increase of the local electric field. Aggregation of a protein within a solution as kind of phase transition which is described by three parameters: a critical concentration of protein within the fluid phase, an aggregation enthalpy and a fractal exponent describing the geometry/topology of the protein aggregates.

### Aggregation Formation Mechanisms and Photophvsical Characteristics:

Both insulin and alcohol molecules in aqueous solutions exhibit the formation of composite/nanocomposite molecular structure formation. Both are multi-phasic composites. In an aqueous solution free of metal ions, insulin exists as a mixture of monomer, dimer, tetramer, hexamer and higher aggregates, proportions depending on the concentration. In the presence of zinc ions, the hexamer species prevails. Zinc insulin hexamers are packed into rhombohedral 2 Zn insulin crystals. The diameter and the height of the hexamers are approximately 50 Angstroms and 35 Angstroms respectively. Its structure is made from hydrophobic (non-polar)-hydrophilic (polar) atoms giving rise to heterogeneous structure formation. Water molecules can occupy 30% of the crystal unit cell and can exist under ordered water structure, divided in four groups, as well as under disordered water structure. The existence of hydrophobic pockets or cavities into the water, together to partially filled-water pockets give rise to formation of nanocomposite structures which can be treated as “defects”. Their shape and geometry can be changed by changing the by a small conformational change of the protein structure and that water molecules exposed to the outside of the protein molecule become partially occupied and therefore disordered. Changing the ratio between hydrophobic and hydrophilic surfaces by some perturbation will largely affect the arrangement and flexibility of water molecules, an enhanced index of refraction contrast results, giving rise to local field enhancement and significant gain due to nonlinear effects, as well as enhanced photon tunability.

The process of insulin aggregation in aqueous solutions of was studied by a fast dynamic light scattering method (FDLS). The hydrodynamic radius of the smaller particles was about 2.8 nm, which is equivalent to that of an insulin hexamer. On the other hand, larger aggregates were growing up to about 600 to about 800 nm. Apparently, the results obtained by FDLS suggested the insulin aggregates are formed by the diffusion limited aggregation (DLA) mechanigm. If the above suggestion is true, the aggregates should have a fractal structure. If so, a fractal geometry would enhance lensing and guiding effects, together with the clathrate-like formation of water of different index of refraction, and presence of non-linear mechanisms. Therefore, insulin polymers (examers) as well as larger aggregates, because of their heterogeneous structure resemble nanocomposites of different domains, or even metamaterials, which are smaller as well as significantly larger than the optical wavelength, respectively. Changing the size of the aggregates spectral tunability can be achieved.

### Interfacial Mechanisms:

The polarization processes related to interfacial phenomena (known as Maxwell-Wagner-Sillars polarization) occurring in insulators containing conductive inclusions are governed by a relaxation time:

$$τ = {ɛ}_{0} \frac{( {n}_{i} - 1 ) {ɛ}_{1} + {ɛ}_{2}}{{σ}_{2}} \qquad ( 6 )$$

where ∈₀ is the permittivity of free space, nᵢ is a geometrical factor depending on the shape of the inclusions and their orientation with respect to the polarizing field, ∈₁ and ∈₂ denote the (static) dielectric constants of the matrix and the inclusions, respectively, and σ₂ is the conductivity of the (semi-conductive) inclusions. The latter equation is valid under the restriction that the conductivity of the matrix σ1 is considerably smaller than σ2. ni holds a unique value (“immer” n) provided that the inclusions are identical and have the same axes oriented along the direction of the polarizing electric field. Note that n=3 for spherical inclusions.

Tunability and reconfigurability of the index of refraction contrast can be achieved by, for example, varying the conductivity, pH, concentration, temperature, viscosity, insulin type or combination, chemical, physical, electrical, optical, electro-optical, and/or the geometrical characteristics of the solvent. The heterogeneity of the solution can be maintained constant, by creating colloidal suspensions, binding other molecules, choosing appropriate solvents, changing the pH or any physical and/or chemical parameter, introducing polar or non-polar liquids, or using a micro-fluidic control engine in conjunction to micro-fluidic delivery system. Changing the ratio between the hydrophobia and hydrophilic surfaces by some perturbation such as Dimmer/polymer formation results in the geometry and flexibility of the water molecules being affected, thereby resulting in a change in the index of refraction contrast. Thus, it is proposed that one could design a light valve with enhanced signal characteristics by changing the ratio between the hydrophobic and hydrophilic surfaces as discussed above.

The proposed invention applies to any modalities, wavelength range, or combination thereof. Specifically, in addition to its inherent potential to light wave applications (UV, visible, IR), the present invention also applies to THz, ultrasound, MRI, electromagnetic, nuclear and x-ray applications, or any combination thereof, for detection, disease treatment, communication, signal enhancement/shaping applications, and/or various other medicines or medical applications.

Insulin molecules have been used as part of a nano-shell-based drug delivery system for tumor photoablasion. Specifically, release of insulin from NIPAAm-coAAm hydrogels with nano-shells embedded in their structure are being used for photo-thermal tumor ablation. When tumor cells are treated with nano-shells and then exposed to near infrared light such tumor cells are efficiently killed while neither the nano-shells alone nor the near infrared (833 nm) light had any effect on “healthy” cells.

Thus, as an example, the present invention makes possible a system where photo-thermal tumor ablation can be controlled, besides the factors mentioned above, by changing the ratio between the hydrophobic and hydrophilic surfaces of an aqueous insulin system thereby resulting in a change occurring in the index of refraction contrast.

In certain cases, the high refractive index of dielectric nanoparticles, and polar molecules such as nanocomposites, alcohol, sugar, nano-polymers, salts (including zwitterions), ionic surfactants, enzymes, amino acids, inside a liquid, would make the refractive index of the liquid to become a volume weighted average between refractive indexes of nanoparticles and the liquid phase, giving rise to an amplification of the index of refraction.

This situation offers ample opportunities to explore novel target detection methodologies; an image enhancement can be obtained by doping the background of the targets of interest with dielectric nanoparticles and dielectric molecules, of high index-of refraction, in combination with optical polarimetric detection principles. For instance, doping of polar solvents with dielectric molecules/nanoparticles, and surfactants solutes, could both boost the image quality, and introduce beam steering and shaping characteristics. Based on the experimental observations of this study, light detection and image enhancement, is achieved by means of: (a) modulation of the surrounding background of the target, so that a high contrast-to-background ratio results; (b) enhanced beam shaping and steering; and (c) reduction of light scattering and losses across the interface of two different dielectric media.

### Experimental Evidence:

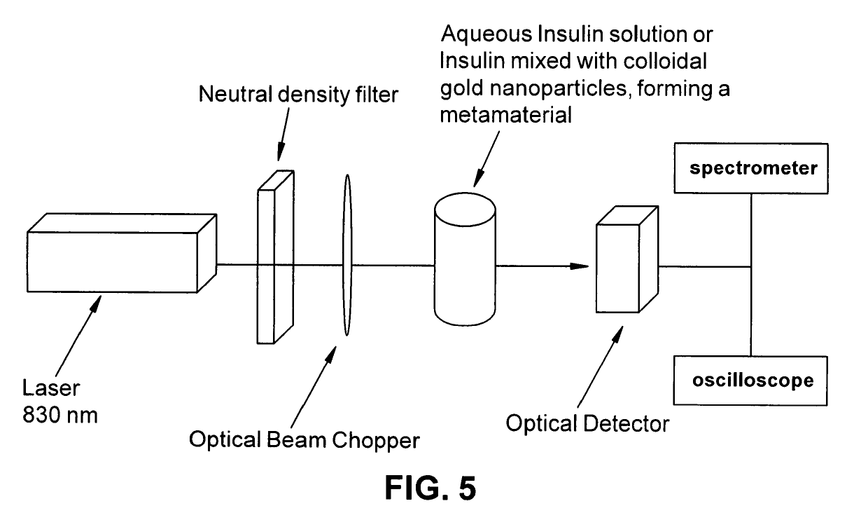

The optical system of the present invention has been operated under transmission geometry. On such suitable set-up is shown in FIG. 5 However, the present invention is not limited to solely this set-up. Rather, all such equivalent set-ups are encompassed within the scope of the present invention.

Regarding the experimental set-up shown in FIG. 5, experiments were performed by using a 830 nm, solid-state laser (Intellite Inc., Minden, Nev.).

The lens-like system comprised a glass tube filled with water and different concentrations of insulin, located 0.7 cm from the receiver. The distance between the laser and the detector was 28 cm. However, measurements were obtained, with always positive results, by placing the glass tube far from the receiver (for instance, in the middle between the transmitter and the receiver), as well as using different shape of tube (rectangular). Detected signals were recorder with progressively increasing concentrations of insulin.

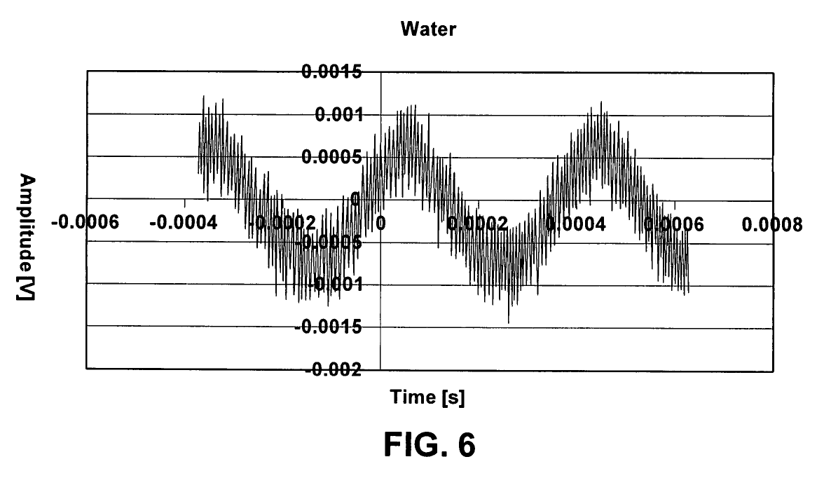

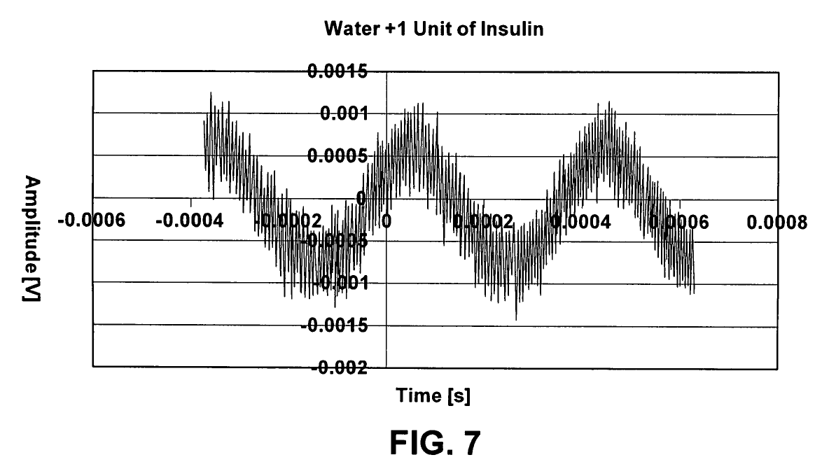

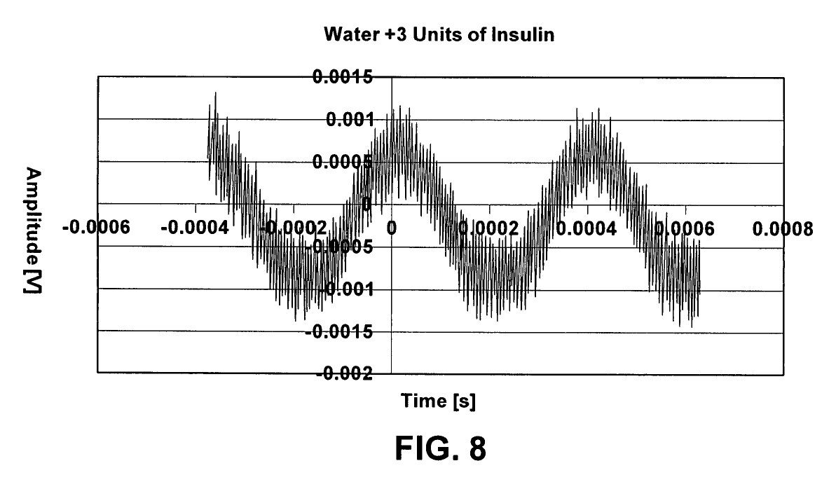

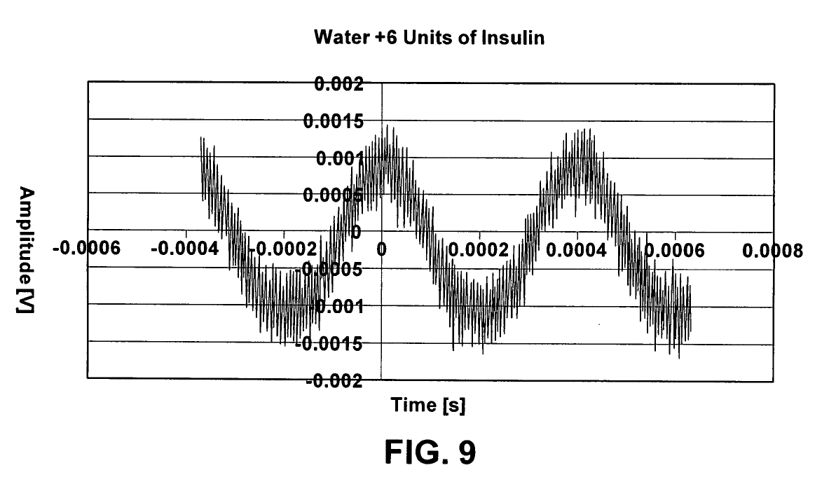

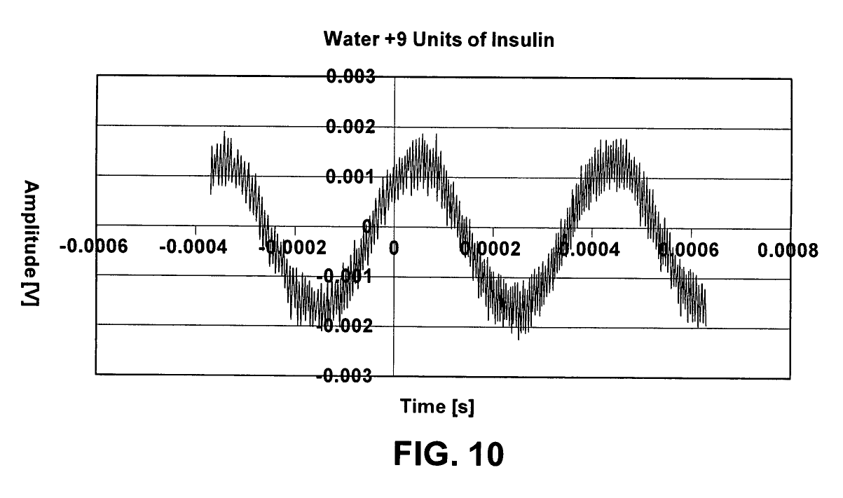

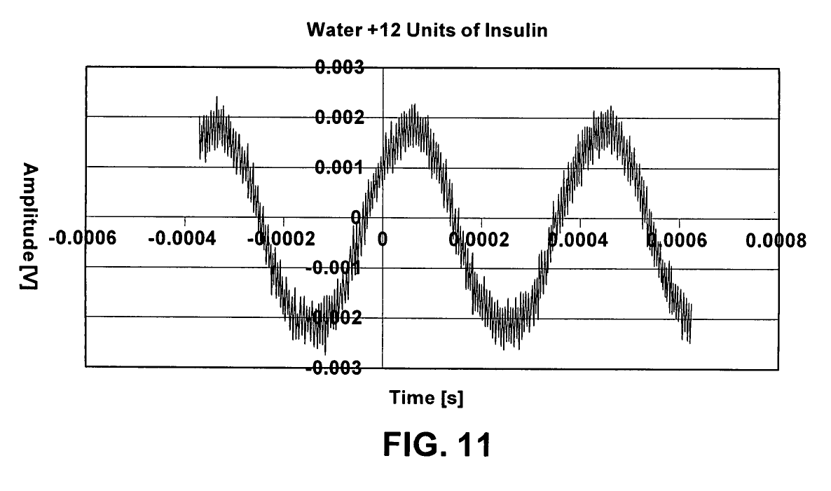

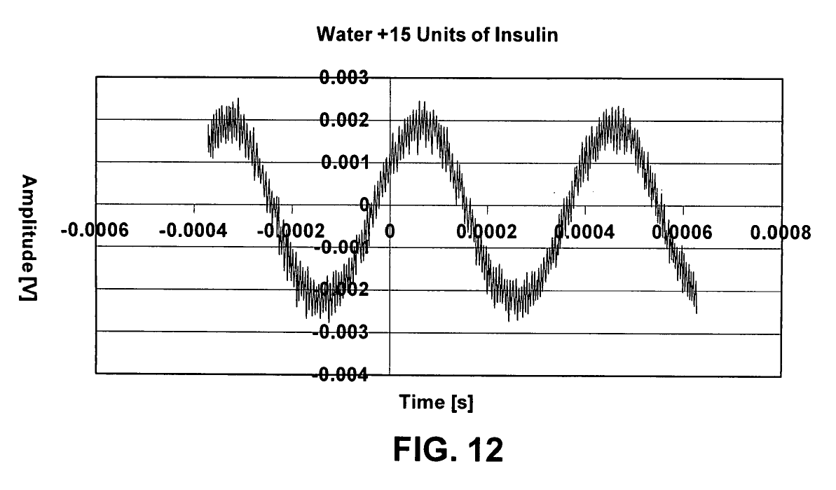

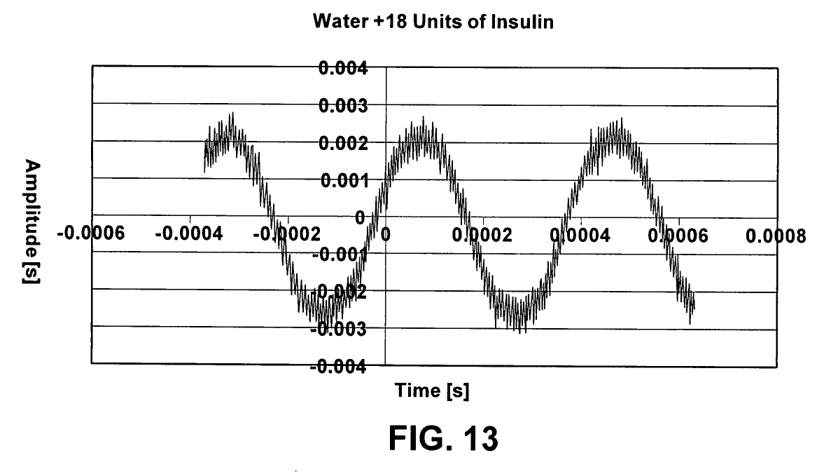

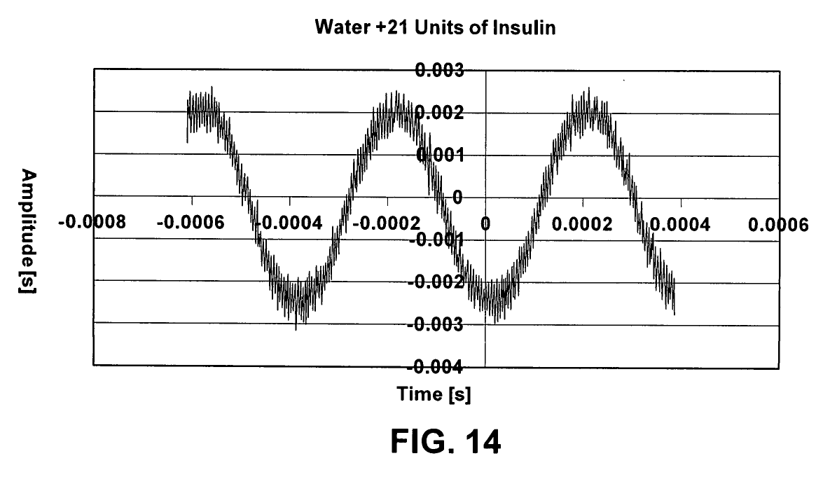

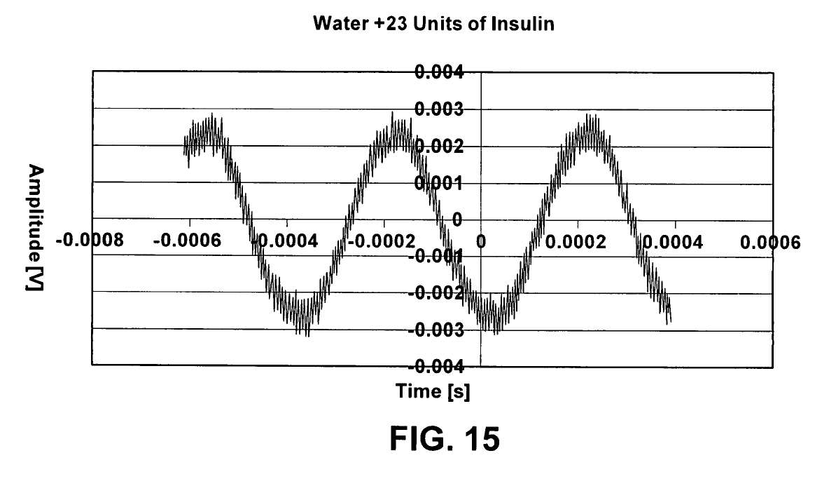

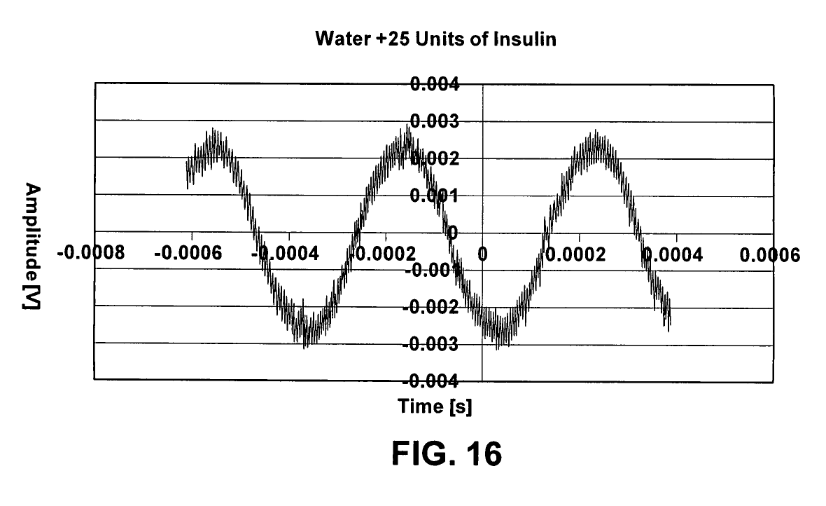

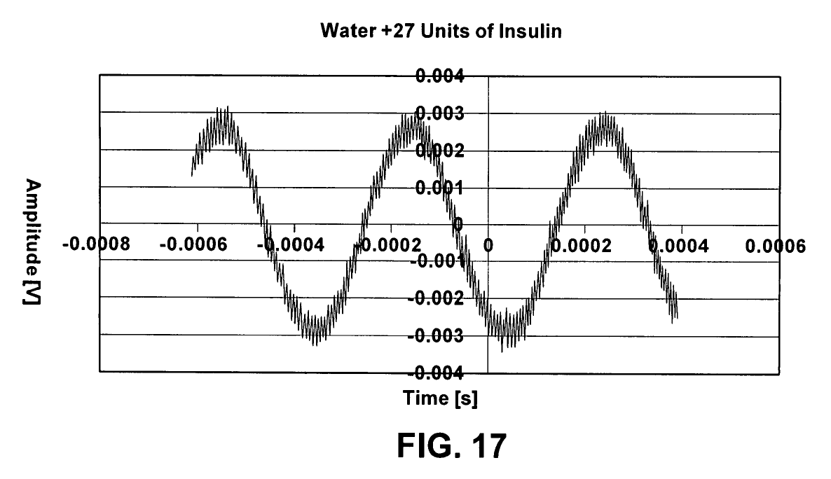

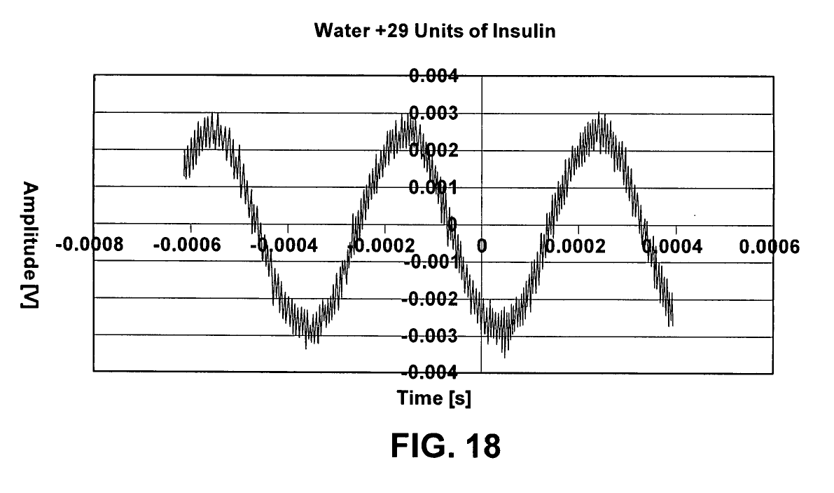

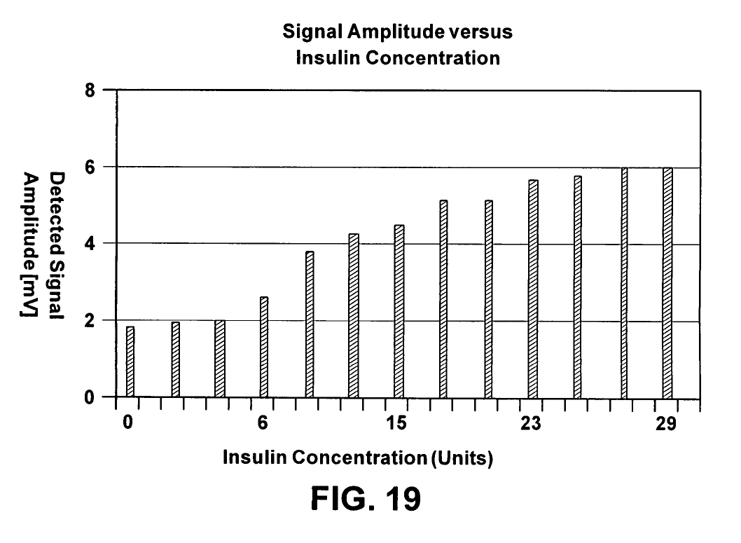

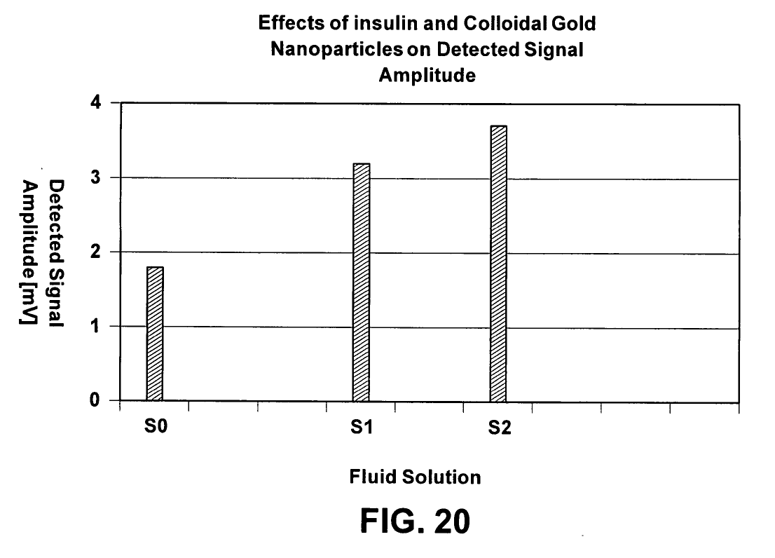

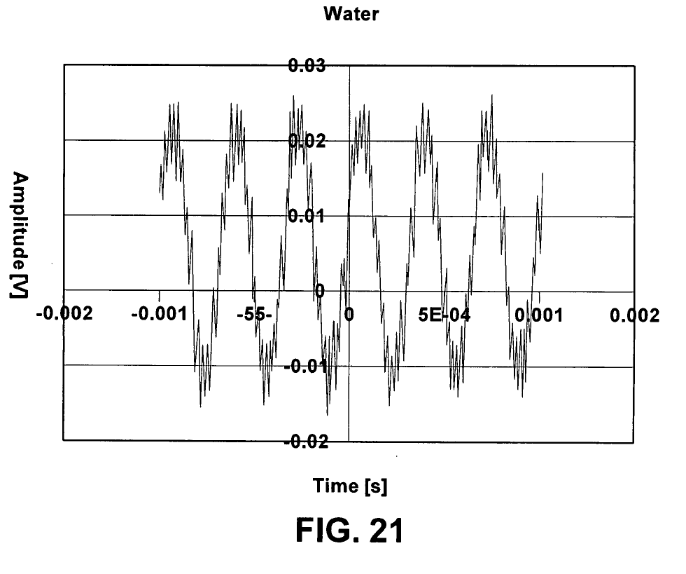

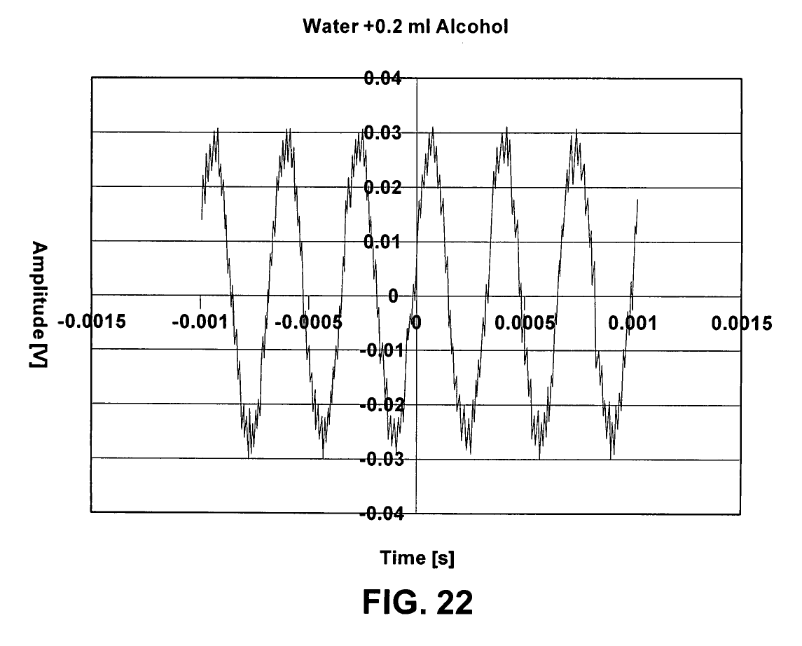

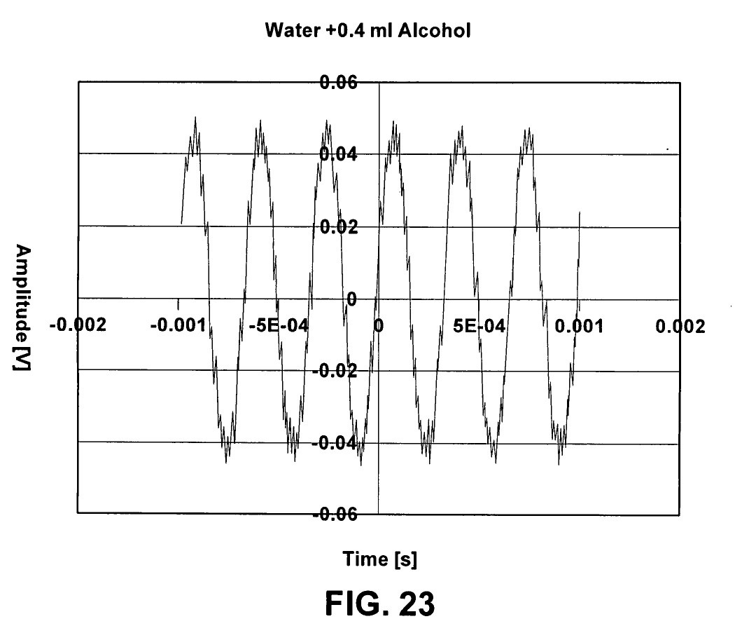

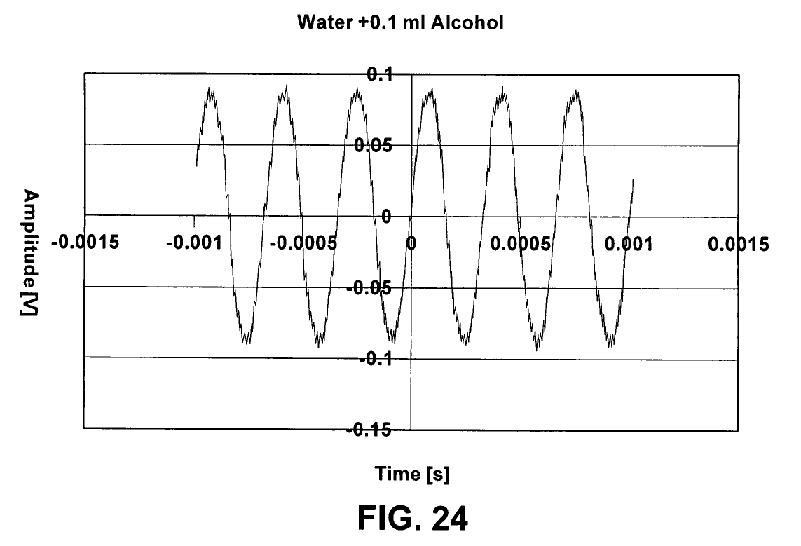

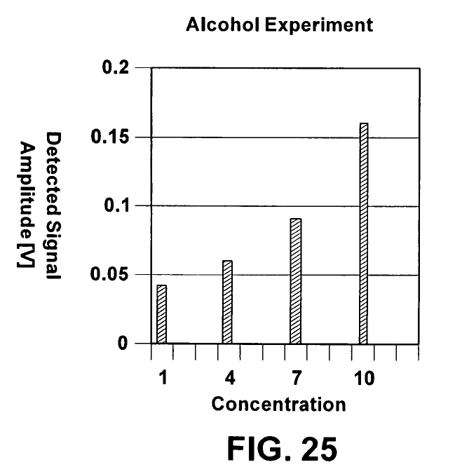

In FIG. 6 the transmitted optical signal through the water, is shown. Transmitted signals through progressively increasing insulin concentrations in the water, is shown in FIGS. 7 through 18. Larger signal-to-noise rations are observed with increasing insulin concentrations. The overall enhancement of the signal characteristics, are shown in FIG. 19, where the detected amplitudes (Vp-p) versus insulin concentrations are shown. By adding 90 nm colloidal gold nanoparticles (Nanoparts Inc) in to the water/insulin mixture, a relative improvement on the detected optical signal is observed, as shown in FIG. 20. In another series of experiment the effect of polar molecules of alcohol solved into the water was studied at different concentrations. The experimental results of FIGS. 21 through 25 indicate an overall signal improvement with increasing insulin concentration.

It is remarkable the fact, that while the signal increase with increasing insulin concentration, the optical noise decreases. This is evidence that the aqueous insulin molecules act as polarization filters, reducing the optical noise. The results of this invention indicate that heterogeneous liquid, with an enhanced index of refraction contrast, form a photonic structure, namely, a metamaterial which can be used to enhance, guide, focus, and amplify incoming light photon signals. A further signal amplification and enhancement, exhibiting metamaterial-like characteristics, has been observed by doping insulin molecules with quantum nanoparticles such as colloidal gold nanoparticles. Signal enhancement arises from several factors such as local electric field enhancement and resonance phenomena, due to increased dipole moments, pronounced light-guiding effects, beam steering, and enhanced depth of focus (DOF). The dielectric behavior of solutions of insulin, as well as with other globular proteins, enzymes, etc., can be accounted for by the rotation of permanent dipoles, giving rise to large birefringence and therefore, large refractive index tuning ranges. The results of this invention also indicate that insulin molecules (a member of the globular proteins family) when mixed with water exhibit metamaterial like-properties and can be used to enhance and amplify incoming light photon signals.

The exploration of the potential of proteins, dipolar ions, and enzymes, in combination with other dopants and quantum nanostructures would lead to the development of novel biocompatible, bio-molecular photonic materials, photonic nano-crystals, lab-on-a chips, optical devices, sensors, light detectors, including weak fluorescence, nano-devices, communications, imaging and therapeutic systems, and/or various industrial and/or medical applications. In fact, optical-active media liquid-filled sensors would respond very well to chemical, biological, and gas species.

Integration of bio-photonics with nano-fluidics may lead to unique control and optical tuning of biomaterials giving rise to reconfigurable and scalable photonic devices.

The following are selected examples of possible applications for the present invention. However, it should be noted that the present invention is not limited thereto.

### Selected Examples of Applications:

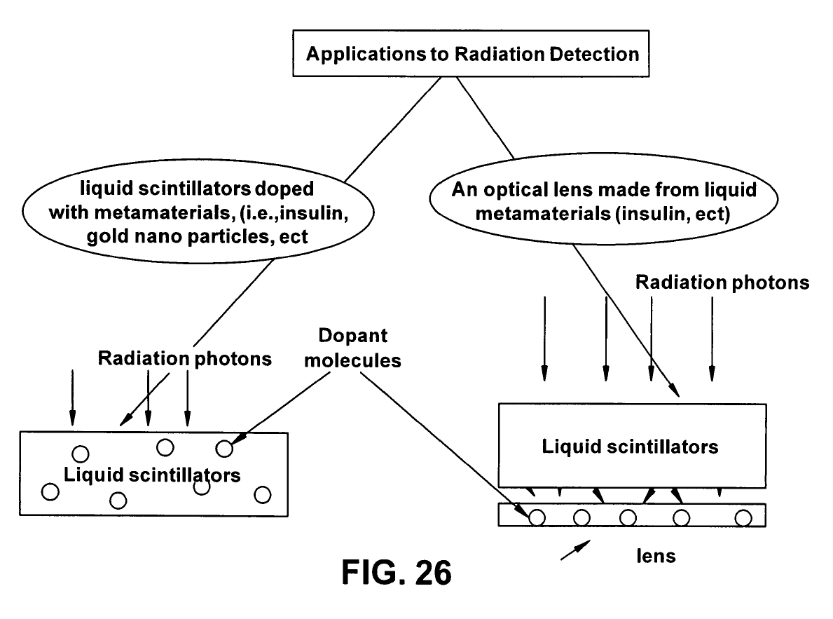

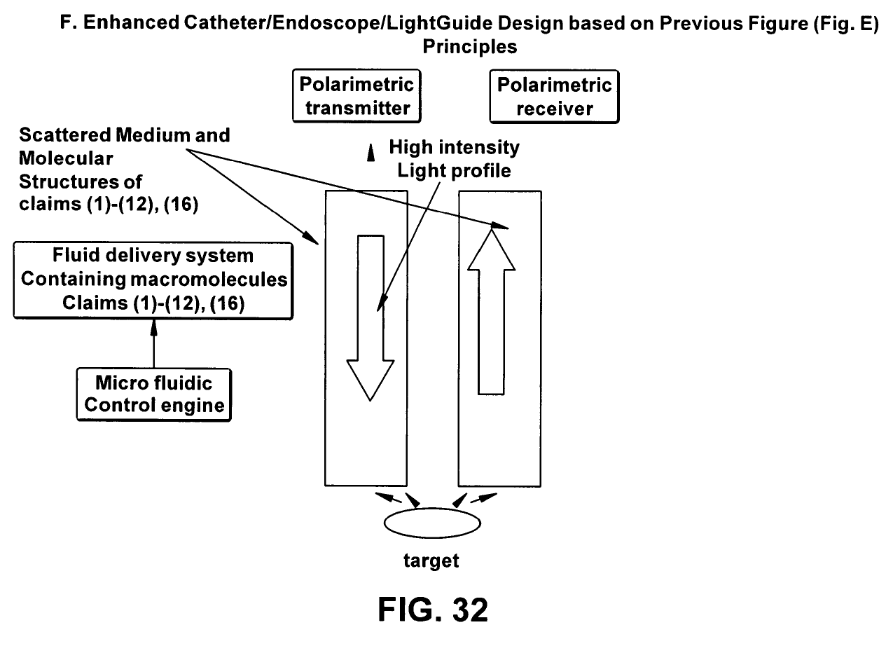

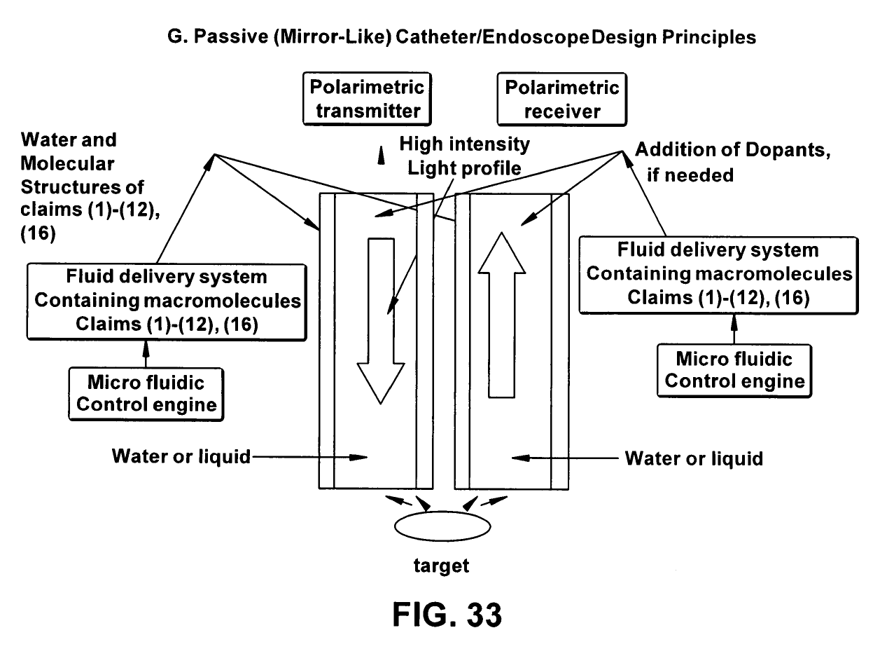

The following examples refer to the applications of this invention which relies on the using, generating, enhancing, or promoting, Molecular structures similar to those described above are illustrated in FIGS. 26 through 37.

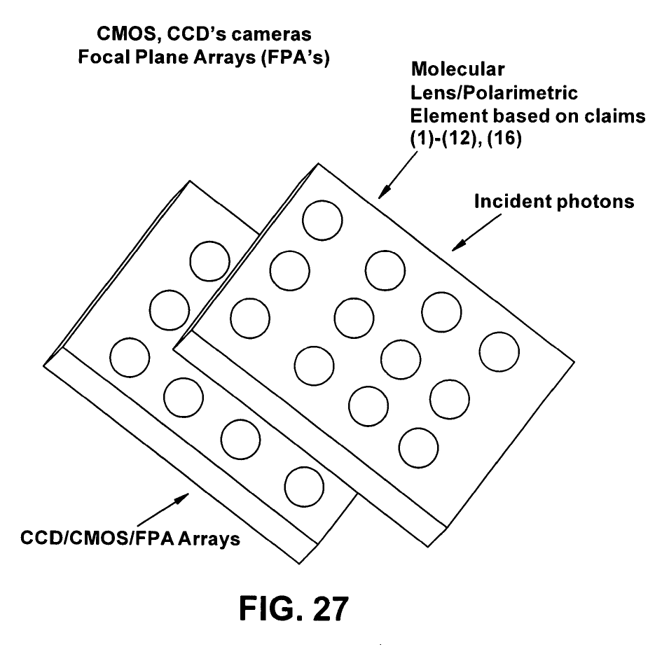

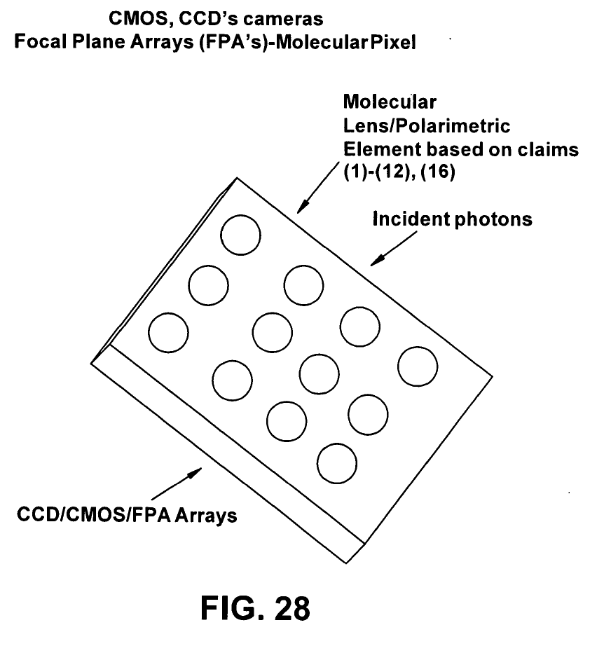

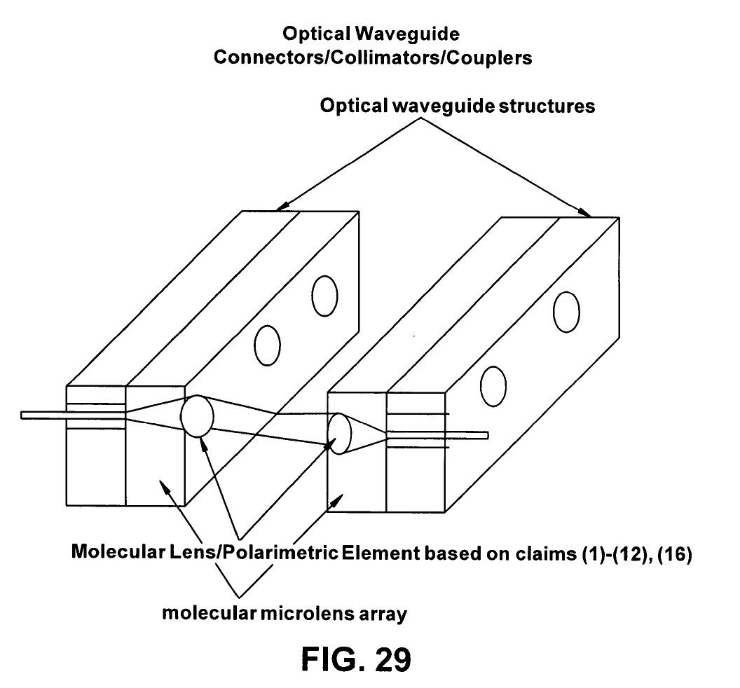

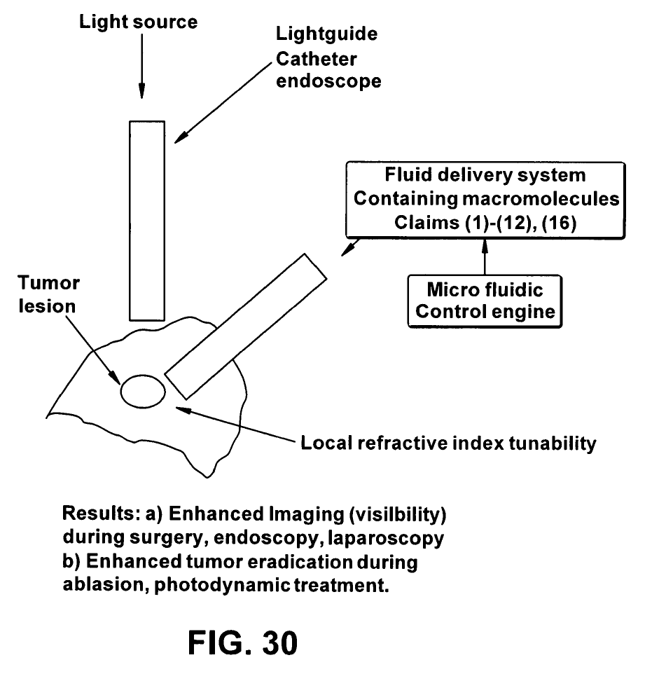

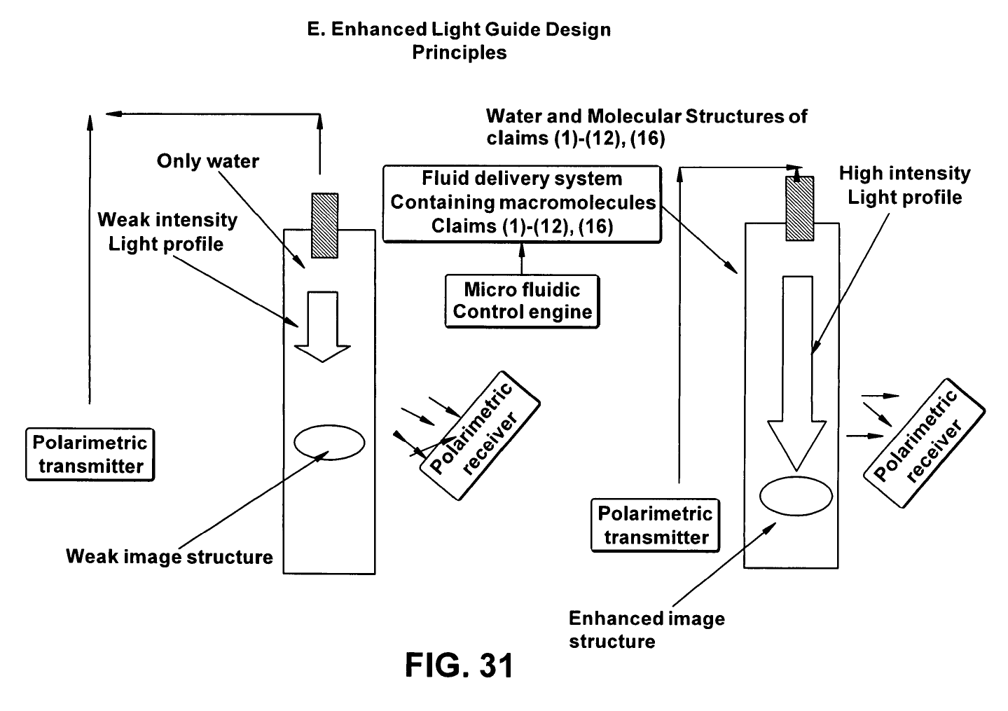

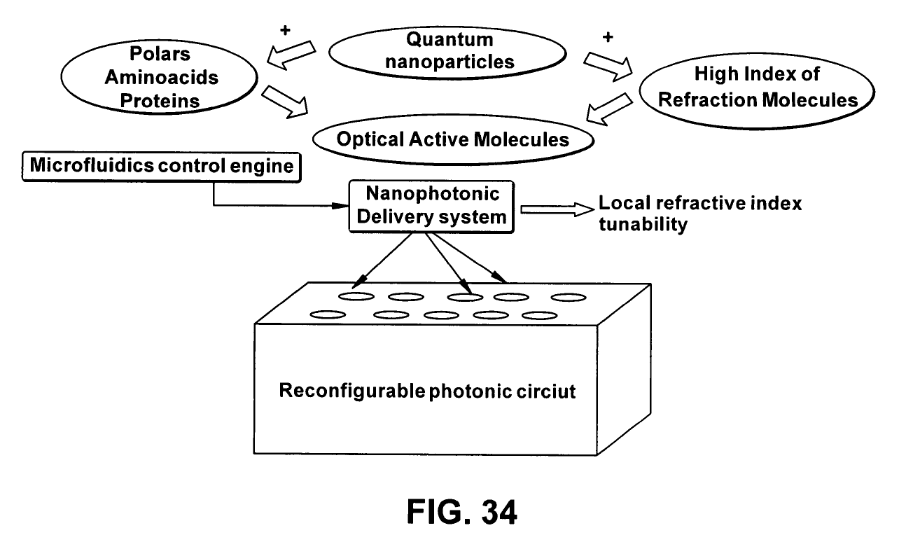

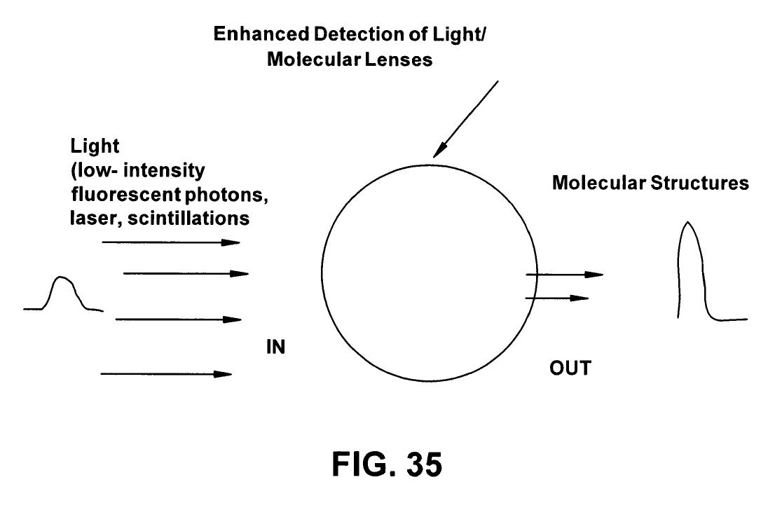

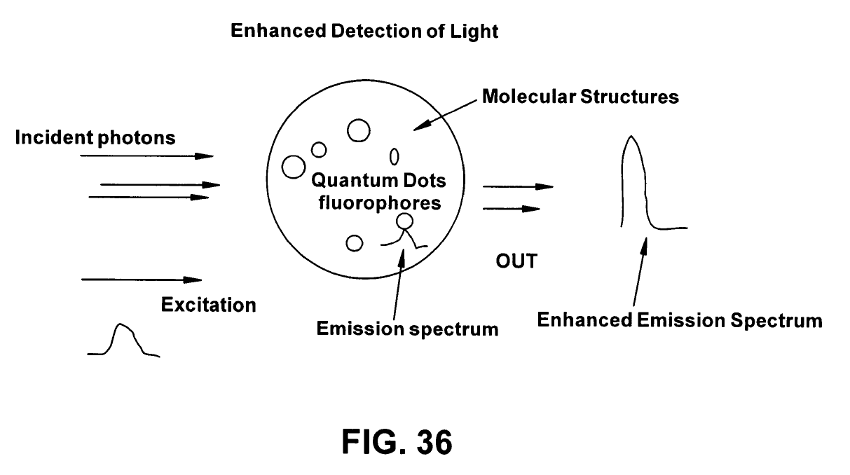

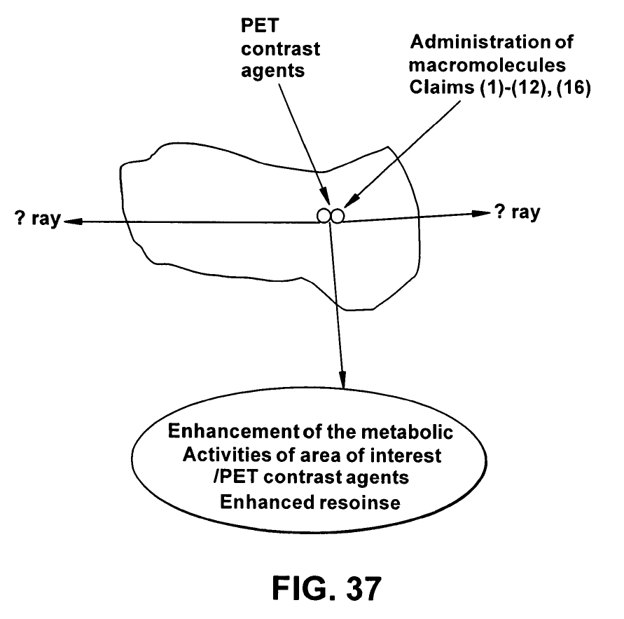

Radiation scintillators (see FIG. 26), imaging applications (see FIGS. 27 and 28), optical communications (see FIG. 29), and enhanced detection, imaging, and treatment of diseases (see FIG. 30). It can be used in conjunction with examples (E), (F), (G) (see FIGS. 31 through 33), which offer enhanced light guide, catheter, endoscope design principles. Reconfigurable photonic circuit using liquid metamaterials (see FIG. 34). This pre-configurable photonic crystal porous filled with liquid materials and quantum nanoparticles. The design of the present invention utilizes various embodiment discussed above, as well as heterogeneous liquid phases with a pronounced index of refraction contrast thereby resembling metamaterials thereby resulting in enhanced signal processing capabilities. It can be applied to imaging, communications, biomedical devices, various industrial applications, and/or other applications. Enhanced detection of light: (see FIG. 35), quantum dot light/fluorophore amplification/light shaping (see FIG. 36), and PET tomography (see FIG. 37).

The molecules discussed above could be administered in PET tomography to enhance metabolic activities or responses from areas of interest, resulting to an enhanced image contrast or enhance the potential of PET contrast agents.

In another embodiment, the present invention generally relates to a method for enhanced detection, imaging, and/or spectroscopical analysis. In one embodiment, the present invention relates to a method for enhancing a target in the presence of one or more backgrounds and/or obscuring conditions, thereby yielding an enhanced contrast and/or one or more specificity characteristics of the target. In another embodiment, the present invention relates to a method that enhances one or more physical, optical and/or signal characteristics of the fluorescence, bioluminescence, chemoluminescence, and/or any other spontaneous, or induced, photoemission mechanisms of a target, thereby yielding enhanced light detection of the target. In still another embodiment, the present invention relates to a method that can optically shape light and introduce target magnification and/or a higher depth of focus. In one embodiment, the methods of the present invention are accomplished by doping a background of a target, or the target itself, with polar molecules, high dielectric particles, nano-polymers, nanoparticles, or any combination of one or more thereof in conjunction with one or more nanostructures, gold or other metal particles/nanoparticles, surface plasmon nanostructures, photomolecules, or any combination of one or more thereof. In still another embodiment, the present invention relates to a method that utilizes one or more polar dopants to further enhance the potential of polarimetric detection and/or imaging.

### Multispectral Polarmetric Imaging Systems:

It is also an objective of this invention is to present novel detection principles, based on all active, multispectral, polarimetric imaging principles, of targets embedded into scattering media. Single energy photons in combination with polarmetric detection techniques yield decent results, but better results could be obtained using multispectral Stokes parameter image differences. The novelty of this contribution consists on the formation of multispectral Stokes parameters image differences, Degree of Linear Polarization (DOLP) image differences, and Mueller Matrix image differences. As a result, high-contrast, high-specificity images can be obtained, by removing the background from the target. Further contrast enhancement of the target with light beam steering capabilities, can be obtained by doping the background surrounding the target with high-index of refraction polar molecules/nanoparticles. The presented optical principles can be successfully applied to a variety of applications such as cancer detection and treatment, molecular imaging, and development of photonics and nanophotonic devices, for a wide-spread gamma of applications, such as defense, and advanced medical diagnostic and analytical devices.

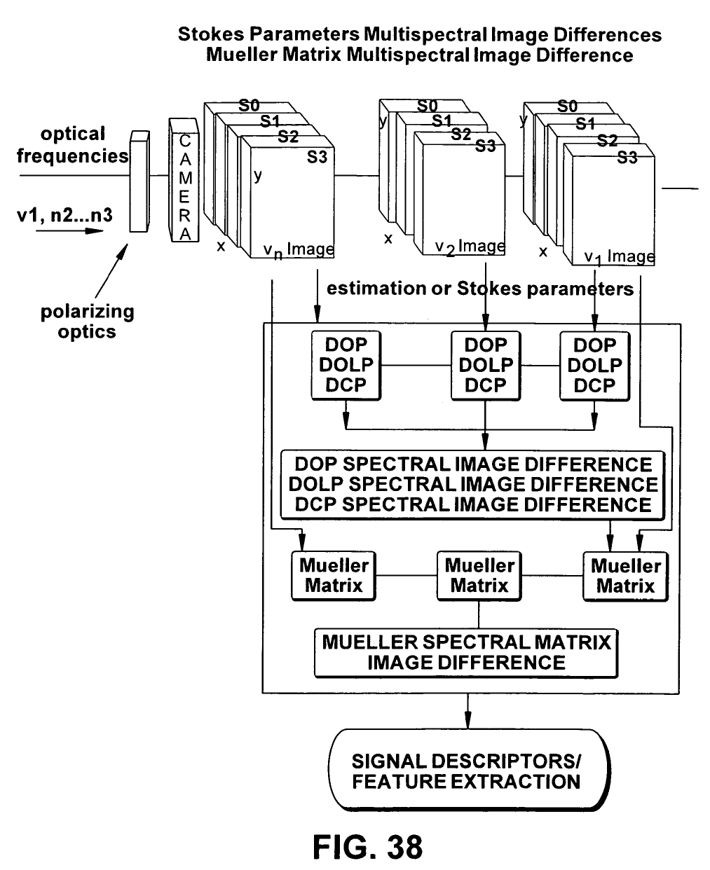

The principles of Multispectral, Multi-fusion, Stokes Parameter/Mueller Matrix Spectral Difference Imaging Polarimetric Detection, are shown in FIG. 38. These principles can be applied to any optical arrangement that allows one to obtain the Stokes polarization parameters and the Mueller matrix of the target/system. The data from the multispectral imaging system can be interpreted as an image of a four-dimensional multi-spectro-polarimetric volume because a measure of radiance is obtained for four independent variables or indices: two spatial variables (x, y), a wave number k (or a wavelength) and S which has only four possible values (S₀, S₁, S₂, S₃). The novelty of these optical polarimetric imaging principles consists in the acquisition of n-optical Mueller matrix polarimetric images, obtained through interrogation of the target with n optical wavelengths. A weighted subtraction of different Mueller matrices, acquired at different wavelengths, yields polarimetrid Mueller matrix image differences, which eliminate interfering background structure, and enhance the detection of the target significantly, due to the high scatter rejection of unwanted radiation. Similarly, extending the above treatment, to the acquisition of n-Stokes parameters multispectral images, it yields to multispectral Stokes parameters image differences. Specifically, the multispectral polarimetric architecture of this study allows images at selected wavelengths to be acquired over different phase retardation angles, namely, over 180° or 360° phase retardation. Subsequent calculations are performed on each pixel of a target scene by measuring all four components of the Stokes vector, as a function of wavelength. In addition, polarimetric parameters-based images such as degree of polarization (DOP) image, degree of linear polarization (DOLP) image, degree of circular polarization (DOCP) image, ellipticity image, orientation image, the Mueller matrix image, and their multi-wavelength image differences, can be calculated and provided in an image format.

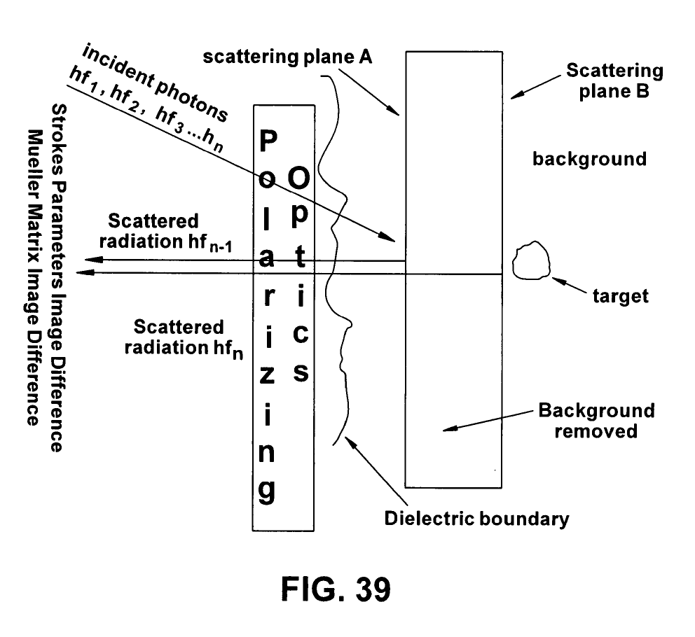

The physics behind the polarimetric image subtraction at different incident optical wavelengths is that, each light photon of different wavelength will reach different depths, and therefore will be scattered from two different planes A and B (let consider for simplicity two distinct optical wavelengths). A schematic of the underlying process is shown, in FIG. 39. Different-energy photons, backscattered from planes A and B, will give rise to the formation of two distinct images with different polarimetric and energy information. These images can be expressed in terms of the Stokes parameters and Mueller matrix formalism of the medium/system. A subtraction of these polarimetric images, obtained at different wavelengths, give rise to enhanced Mueller matrix polarimetric image differences, and Stokes polarimetric parameter differences, due to the removal of the background surrounding the target. Depending upon the application and the constraints of the imaging problem, the polarimetric image differences can be expressed either in terms of voxels or in terms of pixels. For instance, each image difference can be visualized as a 3D slice, made up of voxels, where the longitudinal resolution of the image depends strictly upon the optimization of the incident wavelengths, scattering and absorption characteristics of the medium, while the overall image contrast depends upon the target composition, physical parameters, optical parameters, target geometry, color, polarization content, and surrounding background. In other instances, including ideal cases, the image differences can be treated as 2-d images, made up of pixels.

### Multispectral Mueller Matrix Image Difference:

The data from both the multispectral imaging camera can be interpreted as an image of a four-dimensional multi-spectro-polarimetric volume because a measure of radiance is obtained for four independent variables or indices: two spatial variables (x,y), a wave number k (or a wavelength) and S which has only four possible values (S₀, S₁, S₂, S₃).

Interrogation of the sample at multiple wavelengths yields to several Mueller Matrices, expressed as:

$${M}_{( sample ) λ 1 , λ 2 , … , λ n} = ( \begin{matrix}{m}_{11 {λ}_{1} , {λ}_{2} , … , {λ}_{n}} & {m}_{12 {λ}_{1} , {λ}_{2} , … , {λ}_{n}} & {m}_{13 {λ}_{1} , {λ}_{2} , … , {λ}_{n}} & {m}_{14 {λ}_{1} , {λ}_{2} , … , {λ}_{n}} \\ {m}_{21 {λ}_{1} , {λ}_{2} , … , {λ}_{n}} & {m}_{22 {λ}_{1} , {λ}_{2} , … , {λ}_{n}} & {m}_{23 {λ}_{1} , {λ}_{2} , … , {λ}_{n}} & {m}_{24 {λ}_{1} , {λ}_{2} , … , {λ}_{n}} \\ {m}_{31 {λ}_{1} , {λ}_{2} , … , {λ}_{n}} & {m}_{32 {λ}_{1} , {λ}_{2} , … , {λ}_{n}} & {m}_{33 {λ}_{1} , {λ}_{2} , … , {λ}_{n}} & {m}_{34 {λ}_{1} , {λ}_{2} , … , {λ}_{n}} \\ {m}_{41 {λ}_{1} , {λ}_{2} , … , {λ}_{n}} & {m}_{42 {λ}_{1} , {λ}_{2} , … , {λ}_{n}} & {m}_{43 {λ}_{1} , {λ}_{2} , … , {λ}_{n}} & {m}_{44 {λ}_{1} , {λ}_{2} , … , {λ}_{n}}\end{matrix} ) \qquad ( 7 )$$

The above Mueller matrices of the sample are function of the optical properties of the medium, at multiple incident light wavelengths.

For instance, considering interrogation of the sample at two distinct wavelengths, one can obtain the q^{th} measurement of the irradiance measurements, for two images as:

$$\begin{matrix}\begin{matrix}{\vec{S}}_{out , {λ}_{1}} ( q ) = {M}_{sys} {\vec{S}}_{i n , {λ}_{1}} \\ = {M}_{LP 2} {M}_{LR 2 (} ( q ) {M}_{sample , {λ}_{1}} ( q ) {M}_{LP 1} ( q ) {\vec{S}}_{i n}\end{matrix} & ( 8 ) \\ \begin{matrix}{\vec{S}}_{out , {λ}_{2}} ( q ) = {M}_{sys} {\vec{S}}_{i n , λ 2} \\ = {M}_{LP 2} {M}_{LR 2 (} ( q ) {M}_{sample , {λ}_{2}} {M}_{L R 1} ( q ) {M}_{LP 1} ( q ) {\vec{S}}_{i n}\end{matrix} & ( 9 )\end{matrix}$$

where S̅ₒᵤₜ(q) and S̅ᵢₙ are the Stokes parameters at the output and input of the optical system respectively, at two wavelengths; M_{LP1}(q) and M_{LP2}(q) are the Mueller matrices of ideal polarizers with their transmission axes oriented along the horizontal x direction, and M_{LR1}(q) and M_{LR2}(q) are the Mueller matrices of the quarter wave linear retarders in the polarization state generator and the polarization state analyzer, respectively.

$$\begin{matrix} {M}_{LP 1} = {M}_{LP 2} = \frac{1}{2} ( \begin{matrix}1 & 1 & 0 & 0 \\ 1 & 1 & 0 & 0 \\ 0 & 0 & 0 & 0 \\ 0 & 0 & 0 & 0\end{matrix} ) & ( 10 ) \\ {M}_{L R 1} ( q ) = ( \begin{matrix}1 & 0 & 0 & 0 \\ 0 & {cos}^{2} 2 γ q & sin 2 γ q cos 2 γ g & - sin 2 γ {q}_{0} \\ 0 & cos 2 γ q sin 2 γ g & {sin}^{2} 2 γ q & cos 2 γ q \\ 0 & sin 2 γ q & - cos 2 γ q & 0\end{matrix} ) & ( 11 ) \\ {M}_{LR 2} ( q ) = ( \begin{matrix}1 & 0 & 0 & 0 \\ 0 & {cos}^{2} 10 γ q & sin 10 γ q cos 10 γ q & - sin 10 γ {q}_{0} \\ 0 & cos 10 γ q sin 10 γ q & {sin}^{2} 10 γ q & cos 10 γ q \\ 0 & sin 10 γ q & - cos 10 γ q & 0\end{matrix} ) & ( 12 ) \\ {M}_{sample} = ( \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ) & ( 13 )\end{matrix}$$

Substituting (10)-(13) into both (8) and (9) and carrying out the appropriate trigonometric transformations, one can show that the output irradiance is given by the first element of the output Stokes vector, s₀ₒᵤₜ(q), a polarimetric Mueller-matrix image difference can be defined as:

$$( \begin{matrix}{m}_{11 {λ}_{n}} & {m}_{12 {λ}_{n}} & {m}_{13 {λ}_{n}} & {m}_{14 {λ}_{n}} \\ {m}_{21 {λ}_{n}} & {m}_{22 {λ}_{n}} & {m}_{23 {λ}_{n}} & {m}_{24 {λ}_{n}} \\ {m}_{31 {λ}_{n}} & {m}_{32 {λ}_{n}} & {m}_{33 {λ}_{n}} & {m}_{34 {λ}_{n}} \\ {m}_{41 {λ}_{n}} & {m}_{42 {λ}_{n}} & {m}_{43 {λ}_{n}} & {m}_{44 {λ}_{n}}\end{matrix} ) - ( \begin{matrix}{m}_{11 {λ}_{n - 1}} & {m}_{12 {λ}_{n - 1}} & {m}_{13 {λ}_{n - 1}} & {m}_{14 {λ}_{n - 1}} \\ {m}_{21 {λ}_{n - 1}} & {m}_{22 {λ}_{n - 1}} & {m}_{23 {λ}_{n - 1}} & {m}_{24 {λ}_{n - 1}} \\ {m}_{31 {λ}_{n - 1}} & {m}_{32 {λ}_{n - 1}} & {m}_{33 {λ}_{n - 1}} & {m}_{34 {λ}_{n - 1}} \\ {m}_{41 {λ}_{n - 1}} & {m}_{42 {λ}_{n - 1}} & {m}_{43 {λ}_{n - 1}} & {m}_{44 {λ}_{n - 1}}\end{matrix} ) \qquad ( 14 )$$

and vice-versa. Generally, we can generate n-Mueller matrices, corresponding to n-interrogating wavelengths. By subtracting the 16 Mueller matrix elements of one matrix one by one, acquired at one wavelength, by those acquired at different wavelengths, i.e., m_{11λ2}-m_{11λ1}, and so on, at predetermined combinations, significant information regarding the nature of the target can be achieved. Typically, there are several experimental techniques to generate the full-16 element Mueller matrix.

### Multispectral Stokes Polarization Parameters Image Differences:

The degree of polarization (DOP), degree of linear polarization (DOLP), degree of circular polarization (DOCP), ellipticity, and orientation also can be estimated in terms of Stokes parameters, as

$$\begin{matrix}DOP = \frac{{( {S}_{1}^{2} + {S}_{2}^{2} + {S}_{3}^{2} )}^{1 / 2}}{{S}_{0}} & ( 15 ) \\ DOLP = \frac{{( {S}_{1}^{2} + {S}_{2}^{2} )}^{1 / 2}}{{S}_{0}} & ( 16 ) \\ DOCP = \frac{{S}_{3}}{{S}_{0}} & ( 17 ) \\ e = \frac{b}{a} = \frac{{s}_{3}}{{s}_{0} + \sqrt{{s}_{1}^{2} + {s}_{2}^{2}}} & ( 18 ) \\ η = \frac{1}{2} arctan [ \frac{{s}_{2}}{{s}_{1}} ] & ( 19 ) \\ ɛ = \sqrt{1 - {e}^{2}} & ( 20 )\end{matrix}$$

and S₀, S₁, S₂, S₃ are the Stokes vectors, e, η, and ∈ are the ellipticity, azimuth, and eccentricity, respectively. In general, multiple wavelengths can be utilized to interrogate the target. As a result exploration and arithmetic manipulation of S₀, S₁, S₂, S₃, obtained at different wavelengths, such as subtraction, addition, multiplication, division or combination of them, can enhance the image process, giving rise to Stokes polarization parameters image differences and the like:

({square root over (S₁²+S₂²+S₃³))})_{λ}_{ₙ}−({square root over (S₁²+S₂²+S₃³))})_{λ}_{_{n−1}} (21)

(S_{0,1,2,3})_{λn}−(S_{0,1,2,3})_{λn-1} (22)

(DOP)_{λn}−(DOP)_{λn-1} (23)

(DOLP)_{λn}−(DOLP)_{λn-1} (24)

(DOCP)_{λn}−(DOCP)_{λn-1} (25)

(e)_{λn}−(e)_{λn-1} (26)

(η)_{λn}−(η)_{λn-1} (27)

(∈)_{λn}−(∈)_{λn-1} (28)

### Molecular Nanophotonics Contrast Agents:

The depth-of-Field (DOF) of such imaging system would be offered as:

$$DOF = \frac{{k}_{2} n λ}{( {NA}^{2} )} \qquad ( 29 )$$

where, NA is the numerical aperture of the optical system,

n the index of refraction of the polar-doped solvent,

λ is the optical wavelength of interest.

On the average, the index of refraction of a liquid phase doped with high index of refraction nanoparticles/polar molecules/ions, is function of the concentration of the solute (S), the optical wavelength λ, and the temperature of the medium T, according to:

$$n ( S , T , λ ) = {n}_{0} + ( {n}_{1} + {n}_{2} T + {n}_{3} {T}^{2} ) S + {n}_{4} {T}^{2} + \frac{{n}_{5} + {n}_{6} S + {n}_{7} T}{λ} + … \qquad ( 30 )$$

### Experimental Setup and Results:

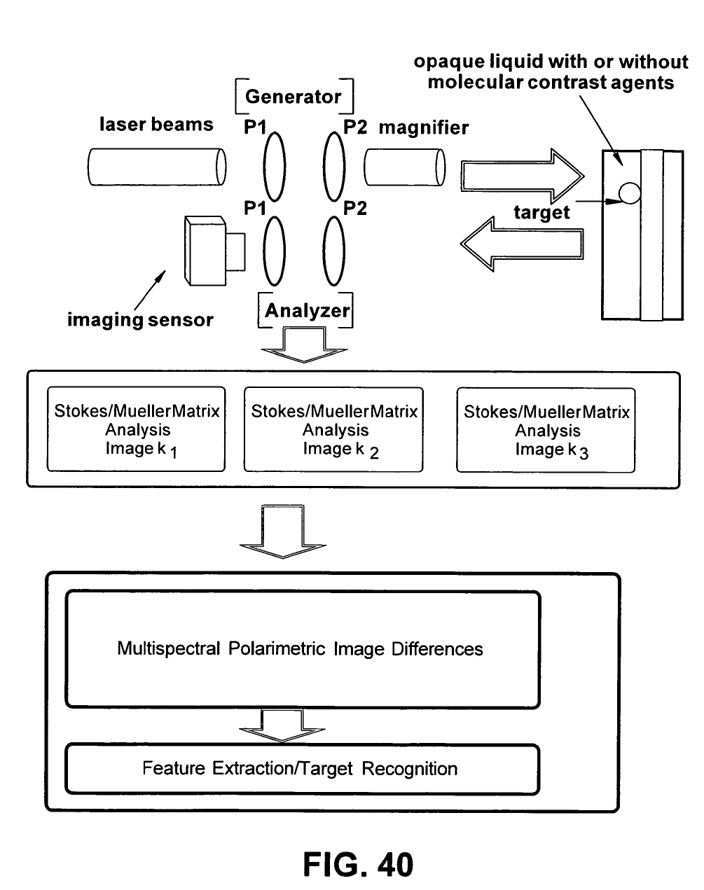

Experiments were performed under backscattered polarimetric geometry, as shown in FIG. 40. The test-image phantom, consisted of one polystyrene microsphere (⅛″ diameter) (Polysciences Inc), embedded suspended on the surface of a white plastic hollow cylinder.

The index of refraction for the polystyrene microsphere and the white plastic hollow cylinder is 1.6, and 1.48, respectively. The phantom was placed inside a glass test tube (1.9 cm diameter), filled with 10 ml of water and 1.2 ml. of skim milk. Skim milk is a scattering agent that contains predominantly casein (0.05 to 0.3 μm) micelles, suitable for Mie scattering studies. The spacing between the microsphere and the edge of the glass envelope was approximately 1 mm. The phantom was interrogated by two laser beams, operating at 633 nm (JDS Uniphase, He—Ne laser), and 785 nm (Intellite Inc., Minden, Nev., solid-state laser), respectively.

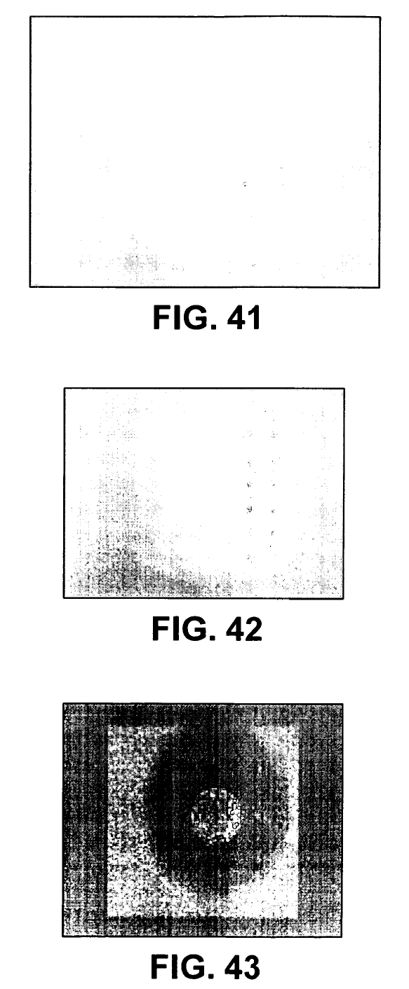

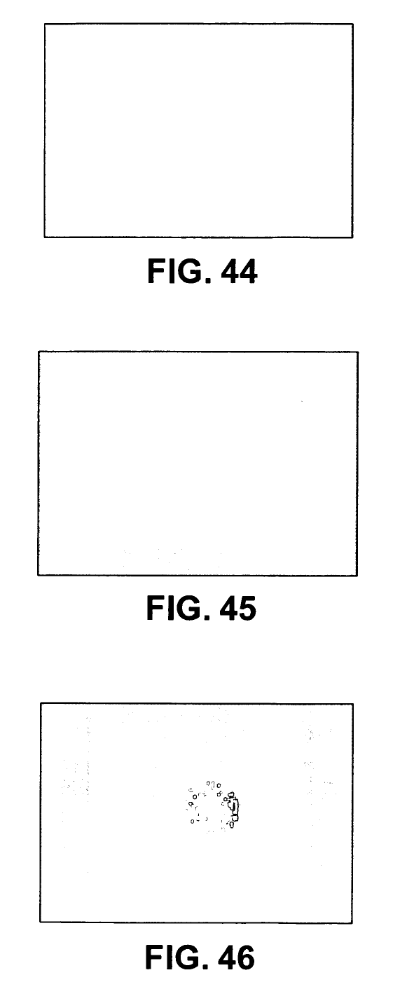

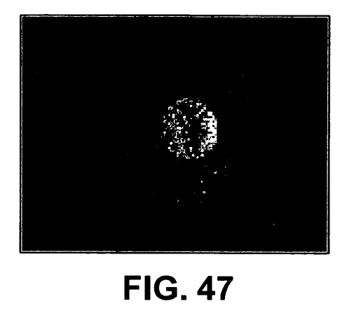

The transmitter system consisted of a λ/4 retardation plate and a linear polarizer placed in the front of the laser beam. The receiver system consisted of a λ/4 retardation plate and a linear polarizer placed in the front of a sixteen-bit thermo-electrically cooled CCD camera from Roper Scientific. In a more general design, a set of photoelastic modulators (PEM) or liquid retarders would be placed in the front of the transmitter and analyzer polarization elements. For each image exposure, sixteen single frames are obtained, one at every 22.5° angle of rotation for a full 360° rotation range, and averaged together, so that average polarimetric images were obtained. The acquired images were processed in order to obtain the DOLP using the Polarimetric Measurement Matrix Method. The Stokes parameter S₀ image of a microsphere embedded at a skim milk-water, obtained at 633 nm and 785 nm, are shown in FIGS. 41 and 42, respectively. On both images, the target is blurred, barely visible, with artifacts. The image difference, of the two Stokes parameter S₀ images obtained at 785 nm and 633 nm, is shown in FIG. 43. It is observed that the target exhibits better contrast resolution, although significant distortion effects are present. The degree of linear polarization (DOLP) images, for the microsphere sphere embedded into the water-skim milk solution, at 633 nm and 785 nm, are shown in FIG. 44 and FIG. 45. Again, the target appears blurred and barely distinguishable on both images, although the image of the target acquired at 785 nm (FIG. 45) exhibits a better contrast with respect to the image of FIG. 44 (633 nm). In FIG. 46, the DOLP subtraction image of the microsphere embedded at a skim milk-water (785 nm to 633 nm), is shown. It can be observed that DOLP subtraction provides enhanced images, without distortion. In fact, the microsphere, embedded in the water-milk solution, exhibits high contrast and is clearly distinguishable. Similarly, by subtracting √(S₁²+S₂²) images acquired at 785 nm-633 nm, improved contrast is obtained (as seen in FIG. 47), although distortion effects are apparent.

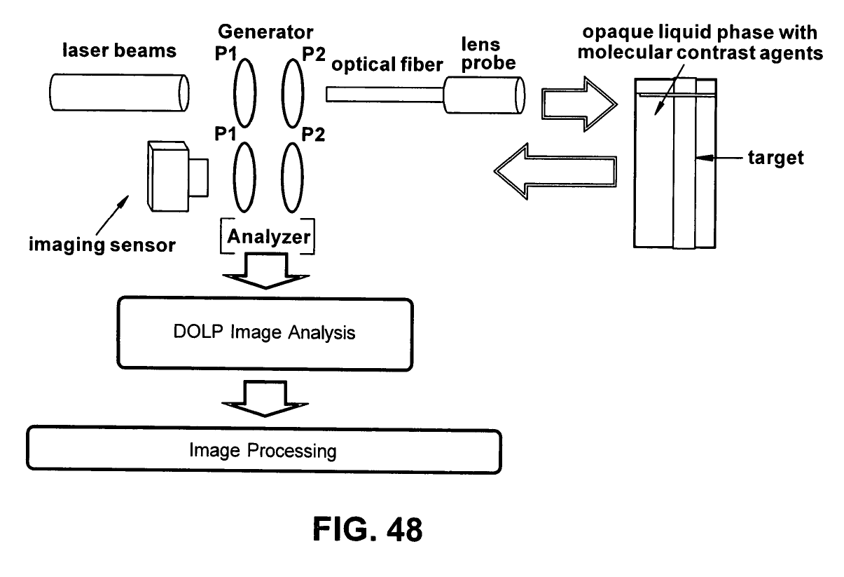

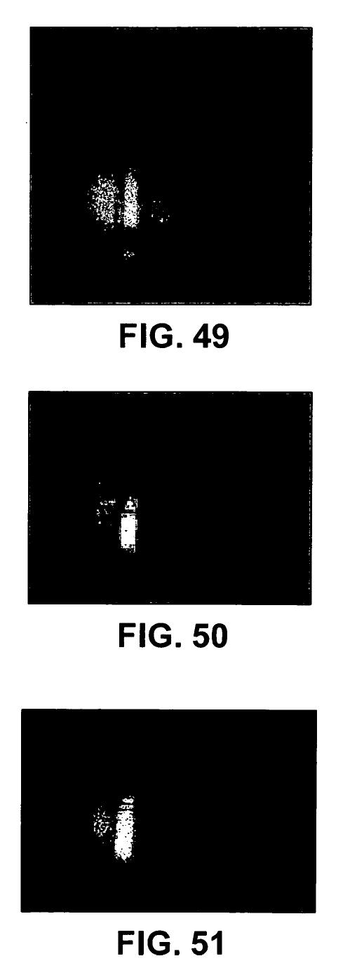

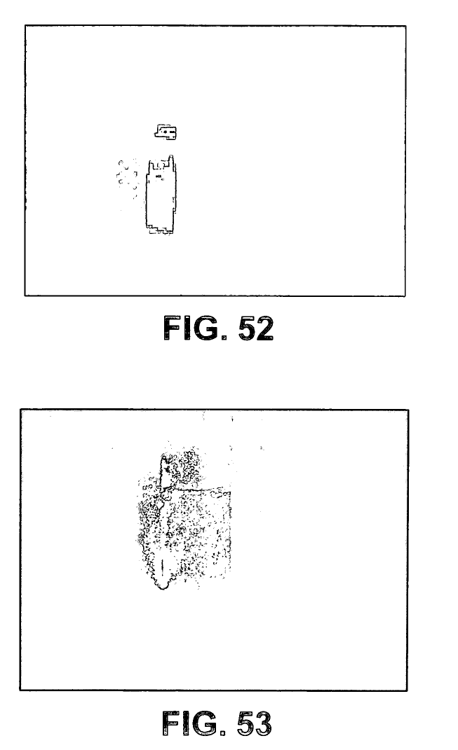

In addition, experiments were performed using a 633 nm He—Ne laser, under backscattered geometry, utilizing water as a solvent, doped with high index of refraction molecules. The experimental setup is shown in FIG. 48. In this series of experiments, the high index of refraction molecules acted as molecular contrast agents. The test-image phantom, consisted of one white plastic hollow cylinder immersed into the liquid phase solution. Originally, a DOLP image of the white plastic hollow cylinder immersed into 5 ml of water has been obtained (FIG. 49). Then, DOLP images of the test phantom immersed into progressively increasing high index of refraction-water concentration solutions, by doping 5 ml of water with 1.66×10⁻² moles/ml, 0.049 moles/ml, and 0.11 moles/ml of CH₃CH(OH)CH₃, with en electric dipole moment of 1.66, were obtained as shown in FIG. 50 through FIG. 52. Similar observations were obtained using salts, sugars, and other high-dielectric polar molecules. A synergetic action of high index of refraction nanoparticles, polar molecules and ions with other biological constituents, quantum nanoparticles/nanostructures, could lead to the enhancement of the imaging content by providing high specificity, pronounced marking and contrast features, and enhanced light/fluorescence detection.

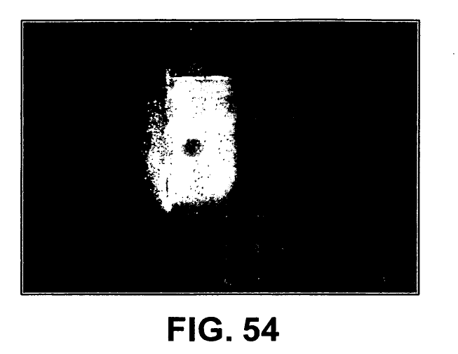

Using the experimental setup of FIG. 48, DOLP images of the microsphere at increasing skim-milk concentration, namely: 20 cc of water mixed with 0.7 cc skim milk, and 20 cc of water mixed with 1.8 cc skim milk, are reported on FIGS. 53, and 54, respectively. It is observed that the higher the concentration of skim-milk the better the image contrast. The answer lies in that skim-milk is composed by predominantly casein (0.05 to 0.3 μm) micelles, which are polar molecules. Increasing the concentration of casein polar molecules (solute) into the solvent (water), amplification of the index of refraction occurs, giving rise to a high-index of refraction, since the index of refraction of a protein solution is proportional to its concentration.

According to:

nₚₛ−nₛ=a×C (31)

where nps is the index of refraction for the protein, and n-s is the index of refraction of the solvent, and a is a proportionality constant sometimes called the specific refractive increment, and C is the concentration of the protein.

There are two key-observations associated with the increasing of the high index of refraction molecular doping of the water: (a) enhancement of the contrast resolution; and (b) enhanced light beam steering capabilities. Interestingly enough, the second of the observations may lead, in the future, to the development of effective cancer treatment methodologies and techniques, by selectively doping areas of surrounding tumor cells, with dedicated high-index of refraction nanoparticles and polar molecules, so that to create pronounced resonance effects and local field effects. Indeed, weak-coupling of the electric dipole of the dielectric nanoparticles with the incident optical field could also contribute to beam focusing and shaping, due to pseudo Stark effects, local field enhancement, and other nonlinear mechanisms.

High-specificity detection techniques capable to identify the presence of precursor amino acids and enzymes in precancerous stages, could lead to early cancer detection, and treatment. Furthermore, the exploitation of the physical principles of this presented in this study, may lead towards the development of innovative imaging methodologies, optical and nanophotonic devices, and advanced diagnostic and analytical instrumentation and systems with enhanced detection capabilities, high contrast, high-specificity, high-depth-of-field (DOF), and variable focusing/steering capabilities. Coupling of the optical field with dc fields, in the presence of high-index of refraction nanoparticles/polar molecules/ions would lead to enhanced Stark effects and detection characteristics.

On the other hand, the multi-fusion, multispectral, imaging polarimetric formalism presented in the present invention in combination with the dopants disclosed herein have unique applications but are not limited to cancer detection and molecular imaging, and the design of advanced diagnostic medical, environmental monitoring and analytical devices. Specifically, it can contribute significantly to the development of molecular imaging technologies, new tools, systems, and techniques, such as imaging devices, and microscopes, coupled with spectral fluorescence detection principles, operating in a wide optical spectrum, with tunable light sources, providing enhanced specificity and sensitivity, for early cancer detection, detection of margins, stage, distribution, and type of cancer, but most importantly for techniques capable to assess the progress of disease and its response to treatment. It also assists oncologists in developing gene-to-gene receptor-specific therapies, earlier cancer diagnosis, choosing stage-specific treatment options, and accurate assessments and follow-ups.

In addition, the use of multispectral, multi-fusion, polarimetric subtraction imaging systems may play a leading role in defense. Typical applications of these polarimetric principles could involve detection of improvised explosive devices (IDE), mine detection, underwater imaging, target embedded in fog or cluttered background or target detection and identification under adverse atmospheric conditions and low-light illumination.

The experimental results indicate clearly that, high-contrast polarimetric Degree of Linear Polarization (DOLP) multispectral image differences, can be obtained from targets embedded in turbid media, under backscattered photon geometries. As a result, it is possible to obtain high-contrast, high-specificity images, by removing the background surrounding the target of interest. Further image enhancement with light beam steering capabilities, can be obtained by doping the surrounding background of the target with high-index of refraction polar molecules/nanoparticles. The presented optical principles can be successfully applied to a variety of applications such as cancer detection and treatment, molecular imaging, and development of photonics and nanophotonic devices, for a wide-spread gamma of applications, such as defense, and advanced medical diagnostic devices.

### Dopant and Other Applications:

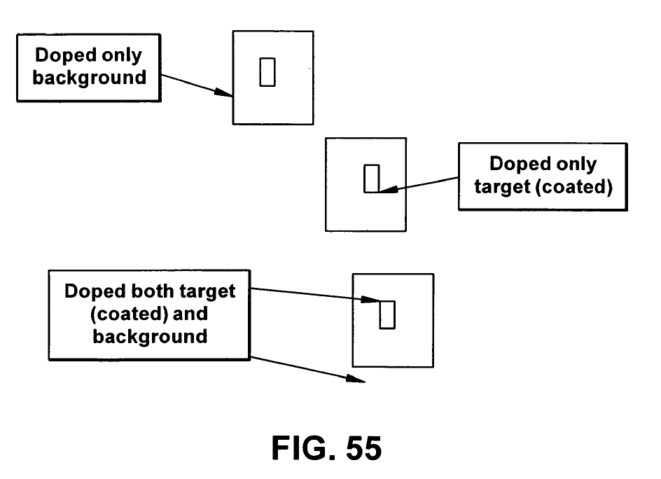

This invention presents a method for enhanced detection imaging, target contrast and target discrimination. The method enhances the physical, optical and signal characteristics of the fluorescence, bioluminescence, chemoluminescence, and/or any other spontaneous or induced photoemission mechanisms. In addition, the method also optically shapes light and introduces target magnification and a higher depth of focus. These methods are detailed in FIG. 55 and are accomplished by modifying the background of the target, the target itself, or both the target and the background of the target with dielectric particles. These dielectric particles produce a different index of refraction. The modifications are accomplished by doping the background of the target or the target itself with high dielectric particles, polar molecules and/or nanoparticles in combination with nanostructures, gold particles, surface plasma nanostructures and/or photomolecules.

The mechanisms for these high-index of refraction nanoparticles, salts (including zwitterions), alcohols, sugars, nanocomposites, nano-polymers, and nanoparticles, using light detection and image enhancement, consisting of several different methods.

These mechanisms include:

(a) modulation of the surrounding background of the target, resulting in a high contrast-to-background ratio. Such a method enhances the performance of the current light detection processes, and imaging systems/techniques;

(b) reduction of light losses at the liquid-glass interface;

(c) high-specificity detection related to the presence of precursor amino acids and enzymes in precancerous stages, contributing to early cancer detection, and treatment;

(d) doping the surrounding tissue background with enzymes and amino acids that possess dedicated tumor cell-binding characteristics;

(e) development of imaging methodologies and advanced diagnostic instrumentation, including both macroscopic (bulk imaging), and microscopic imagery (or a combination thereof), as well as other modalities, liquid lenses, optical endoscopic probes, optical biopsy instrumentation. These methodologies and/or instrumentations are doped with high-dielectric ions or polar molecules, possessing enhanced contrast-high-specificity, high-depth-of-field (DOF), and variable focusing capabilities, according to:

$$DOF = \frac{{k}_{2} n λ}{( {NA}^{2} )} \qquad ( 29 )$$

where, NA is the numerical aperture of the optical system,

n the index of refraction of the polar-doped solvent, and

λ is the optical wavelength of interest.

The index of refraction of a liquid phase doped with high index of refraction nanoparticles/polar molecules/ions, is a function of the concentration of the solute (S), the optical wavelength λ, and the temperature of the medium T, according to:

$$n ( S , T , λ ) = {n}_{0} + ( {n}_{1} + {n}_{2} T + {n}_{3} {T}^{2} ) S + {n}_{4} {T}^{2} + \frac{{n}_{5} + {n}_{6} S + {n}_{7} T}{λ} + … \qquad ( 30 )$$

Further applications have been explored including coupling of the electric dipole of the dielectric nanoparticles with the incident optical field, leading to beam focusing and shaping, due to pseudo Stark effects, local field enhancement, and other nonlinear mechanisms. Such a coupling of the optical field with dc fields, in the presence of high-index of refraction nanoparticles/polar molecules/ions would lead to enhanced Stark effects and detection characteristics.

Another application involves synergetic action of high index of refraction nanoparticles/molecules/ions/fluorophores/quantum particles with other biological constitutes, quantum nanoparticles/nanostructures, to maximize the imaging content by providing high specificity, pronounced marking and contrast features, and improved light detection characteristics.

Another application involves the development of techniques aimed to detect catheters, balloons, endoscopic devices, biomaterials, implants, biological matter, and so forth, by developing special coatings based on various molecular structures discussed above, nanocomposites, nanoparticles, or any such combination, (with or without the use of fluorescent/quantum particles/fluorophores/taggers) to enhance the detection of objects (in this instance in place of doping the background, one would deposit said dielectric particles/nanoparticles directly onto the target, such as catheter, probes, implants, biomaterials).

As stated previous, the scenarios involve the two examples shown in FIG. 55. FIG. 55 graphically details doping only the background, only the target, or doping both the target and background. All the above techniques may operate with polarimetric imaging techniques, without excluding other imaging or measuring techniques.

Additional applications involve the development of biotronics, LAB-on-a-CHIPS, new photonic devices or electro-optic devices, and any instrumentation or devices based on these principles. These applications provide an expanding arena for using the technology as do the areas such as optical polymeric techniques and other optical techniques, lenses, and switches. Finally, applications involving micro-fluidic devices, chromatography and micro-sensors all could utilize various aspects of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for generating a photonic structure with one or more metamaterial characteristics comprising the steps of:
providing at least two media wherein both media each have a lipid phase, and wherein at least one medium exhibits a high molecular dipole moment and therefore a high molecular polarization so as to result in an increased index of refraction contrast between the at least two media; and
using the photonic structure created by the at least two media to to yield a photonic structure having one or more metamaterial characteristics.

2. The method of claim 1, wherein the at least one of the at least two media contain insulin molecules that exhibit metamaterial-like characteristics and can be used to enhance, focus and amplify incoming light photon signals.

3. The method of claim 1, wherein the at least one of the at least two media contain insulin molecules in combination with colloidal gold nanoparticles, whereby the combination of the insulin molecules and the colloidal gold exhibit metamaterial-like characteristics and can be used to enhance, focus and amplify incoming light photon signals.

4. A method for amplifying, modulating and/or enhancing electromagnetic and light wave signal characteristics comprising the steps of:
providing at least one optically active macromolecule, high index of refraction molecule, or polar macromolecule designed to amplify, modulate and/or enhance the electromagnetic and light wave signal characteristics through linear and non-linear mechanisms;
providing at least one electromagnetic and/or light source; and
generating unique signal characteristics through the interaction of the at least one optically active macromolecule, high index of refraction molecule, or polar macromolecule and the at least one electromagnetic and/or light source.

5. The method of claim 4, wherein the unique signal characteristics are selected from optical gain, high signal-to-noise ratio, light shaping, local refractive index tunability, brightness, high light intensity, enhanced focusing and depth of focus, spectrally tunable photoresponse, optical control capabilities, or a combination of any two or more thereof.

6. The method of claim 4, wherein the at least one optically active macromolecule, high index of refraction molecule, or polar macromolecule is selected from insulin, other globular proteins, hormones, organic molecules in aqueous solutions or in any other matrix, proteins, enzymes, salts, milk molecules, dipolar ions, polymers, copolymers, block-copolymers, and biological amphiphilic macromolecules, AB-block copolymer hybrid materials, macromolecule aggregation products, multi-phasic composite/nanocomposite structures, or any combination of two or more thereof in a suitable matrix.

7. The method of claim 4, wherein the method can also enhance birefringence and polarization sensitivity, enhanced recognition, imaging, and bio-recognition molecular capabilities.

8. The method of claim 4, wherein the method further permits the utilization, generation, enhancement, and/or promotion of the aggregation of macromolecules.

9. The method of claim 8, wherein the macromolecules are selected from one or more proteins, enzymes, hormones, amino acids, bio-molecules, organic molecules, high index of refraction molecules, polar macromolecules, or suitable combinations of two or more thereof.

10. The method of claim 9, wherein the incomplete mixing of such macromolecules leads to the formation of heterogeneous phases with high polar dipole moments having a pronounced index of refraction contrast and focal refractive index tenability which resemble multi-phasic composites, nano-composites or metamaterials.

11. A method for utilizing, generating, enhancing, or promoting the formation of macromolecular and biological complex systems, or synthetic macromolecules comprising the steps of:
providing at least one macromolecular; and
fusing the at least one macromolecule with at least one synthetic polymer having one or more biopolymer segments with enhanced photophysical and multifunctional capabilities.

12. The method of claim 11, wherein various aspects of the at least one macromolecule can be controlled.

13. The method of claim 12, wherein the various aspects that can be controlled are selected from conductivity, local refractive index tunability, concentration, aggregation enthalpy, fractal exponent conductivity pH, temperature, viscosity, insulin type or combination, chemical, physical, electrical, optical, electro-optical characteristics, the geometrical characteristics of the solvent or matrix, or suitable combinations of two or more thereof.

14. The method of claim 13, wherein the at least one macromolecule are designed to amplify, modulate and/or enhance the electromagnetic and light wave signal characteristics, through linear and non-linear mechanisms, by providing unique signal characteristics.

15. The method of claim 14, wherein the unique signal characteristics are selected from optical gain, high signal-to-noise ratio, light shaping, brightness, high light intensity, enhanced focusing and depth of focus, spectrally tunable photoresponse, optical control capabilities, or suitable combinations of two or more thereof.

16. The method of claim 14, wherein the process can further enhance birefringence and polarization sensitivity, recognition, imaging, and bio-recognition molecular capabilities.

17. The method of claim 14, wherein the at least one macromolecule, high index of refraction molecule, or polar macromolecule is selected from insulin, other globular proteins, hormones, organic molecules in aqueous solutions or in any other matrix, proteins, enzymes, salts, milk molecules, dipolar ions, polymers, copolymers, block-copolymers, and biological amphiphilic macromolecules, AB-block copolymer hybrid materials, macromolecule aggregation products, multi-phasic composite/nanocomposite structures, or any combination of two or more thereof in a suitable matrix.

18. A method for enhancing one or more physical, optical and/or signal characteristics of the fluorescence, bioluminescence, chemoluminescence, and/or any other spontaneous, or induced, photoemission mechanisms via the use of at least one macromolecule comprising the steps of:
providing at least one macromolecule wherein the at least one macromolecule is designed to enhance one or more physical, optical and/or signal characteristics of the fluorescence, bioluminescence, chemoluminescence, and/or any other spontaneous, or induced, photoemission mechanisms;
providing at least one source of fluorescence, bioluminescence, chemoluminescence, and/or any other spontaneous, or induced, photoemission; and
achieving an enhancement of one or more physical, optical and/or signal characteristics of the fluorescence, bioluminescence, chemoluminescence, and/or any other spontaneous, or induced, photoemission mechanisms due to the use of the at least one macromolecule.

19. The method of claim 18, wherein the process further enhances light detection of a target.

20. The method of claim 18, wherein the at least one macromolecule, high index of refraction molecule, or polar macromolecule is selected from insulin, other globular proteins, hormones, organic molecules in aqueous solutions or in any other matrix, proteins, enzymes, salts, milk molecules, dipolar ions, polymers, copolymers, block-copolymers, and biological amphiphilic macromolecules, AB-block copolymer hybrid materials, macromolecule aggregation products, multi-phasic composite/nanocomposite structures, or any combination of two or more thereof in a suitable matrix.

21. A method for optically shaping, focusing, guiding, providing local refractive index tenability, and/or amplifying light comprising the steps of:
providing at least one macromolecule wherein the at least one macromolecule is designed to optically shape, focus, guide, provide local refractive index tenability, and/or amplify light;
providing at least one light source; and
using the interaction of the at least one macromolecule and the at least one light source to achieve a change in the index of refraction contrast and/or the local refractive index tunability of the least one light source.

22. The method of claim 21, wherein the at least one macromolecule, high index of refraction molecule, or polar macromolecule is selected from insulin, other globular proteins, hormones, organic molecules in aqueous solutions or in any other matrix, proteins, enzymes, salts, milk molecules, dipolar ions, polymers, copolymers, block-copolymers, and biological amphiphilic macromolecules, AB-block copolymer hybrid materials, macromolecule aggregation products, multi-phasic composite/nanocomposite structures, or any combination of two or more thereof in a suitable matrix.
